(19) United States
(12) Patent Application Publication
(10) Pub. No.: US 2004/0052387 A1
(43) Pub. Date: Mar. 18, 2004

(54) Piezoelectric film emitter configuration

(75) Inventors: Mark Norris, San Diego, CA (US); James J. Croft III, Poway, CA (US)

Correspondence Address: THORPE NORTH & WESTERN, LLP, P.O. Box 1219, Sandy, UT, 84091-1219, US

(73) Assignee: American Technology Corporation.

(21) Appl. No.: 10/613,540

(22) Filed: Jul. 2, 2003

Related U.S. Application Data
(60) Provisional application No. 60/393,560, filed on Jul. 2, 2002.

(51) Int. Cl. H04R 25/00; H04R 1/20; H04R 1/02

(52) U.S. Cl. 381/190; 381/345

(57) ABSTRACT

A method of preparing a parametric speaker transducer for (i) generating sonic or subsonic audio output by propagating two frequencies having a difference in value equal to the desired sonic or subsonic audio output and (ii) decoupling the two frequencies to generate the desired audio output, the method comprising the steps of:

a. positioning an electrically sensitive, mechanically responsive film over at least one closed-end cavity of a rigid support member within a pressure chamber;

b. applying a pressure differential within the chamber to provide a common cavity pressure substantially different from ambient pressure;

c. sealing the film to the support member while within the pressure chamber to capture the cavity pressure in a permanent configuration; and

removing the sealed film and support member from the pressure chamber, thereby distending the film into an arcuate emitter configuration with respect to the at least one cavity in response to a pressure differential between cavity pressure and ambient pressure on opposing sides of the film to enable constricting and extending of the emitter configuration in response to variations in an applied electrical input at the piezoelectric film to thereby create a compression wave in a surrounding environment. A structural device for implementing this method is also disclosed.

Priority of application No. 60/393,560 filed Jul. 2, 2002 in the U.S. Patent Office is hereby claimed.

### BACKGROUND OF THE INVENTION

1. Field of the Invention

This invention pertains to acoustic emitter devices that use a flexible, piezoelectric film for compression wave generation. Specifically, the present invention relates to film and emitter configurations and related methods for directly generating sonic and ultrasonic compression waves, and indirectly generating a new sonic or subsonic compression wave by interaction of two compression waves having frequencies whose difference in value corresponds to the desired new sonic or subsonic compression wave frequencies, typically referred to as parametric sound.

2. State of the Art

The emerging audio field of parametric speakers is gaining increased attention because of its unique highly directional, focused sound. Nevertheless, prior art parametric devices have yet to realize commercial success in view of numerous deficiencies which have created practical obstacles for desired audio output. In theory, parametric speakers develop audio compression waves by the interaction in air (as a nonlinear medium) of at least two ultrasonic frequencies whose difference in value falls within the audio range. Although two frequencies are sufficient to develop the parametric phenomenon, is will be recognized by those skilled in the art that more than two frequencies can and will typically be applied within a parametric sound system. Accordingly, it is to be understood that where reference is made to two frequencies, additional frequencies are implicitly intended.

Ideally, compression waves generated by a parametric emitter are projected within the air as a nonlinear medium, and are converted by the air to be heard as pure sound. Although there has been a simplistic perception of this basic parametric method, general production of parametric sound for practical applications has eluded the industry for over 100 years. Specifically, the prior art has failed to produce a basic parametric or heterodyne speaker that can be applied in general applications in a commercial manner such as conventional dynamic speaker systems.

A brief history of development of the theoretical parametric speaker array is provided in “Parametric Loudspeaker—Characteristics of Acoustic Field and Suitable Modulation of Carrier Ultrasound”, Aoki, Kamadura and Kumamoto, Electronics and Communications in Japan Part 3, Vol. 74, No.9 (March 1991). Although technical components and the theory of sound generation from a difference signal between two interfering ultrasonic frequencies are described, the practical realization of a commercial sound system has been unsuccessful. Note that this weakness in the prior art has continued despite the assembly of large parametric speaker arrays consisting of as many as 1410 piezoelectric transducers yielding a speaker diameter of 42 cm. It is important to note that virtually all prior art research in the field of parametric sound has been based on the use of conventional ultrasonic transducers, typically of bimorph character.

U.S. Pat. No. 5,357,578 issued to Taniishi in October of 1994 introduced alternative solutions to the dilemma of developing a workable parametric speaker system. Hereagain, the proposed device comprised a transducer that radiated the dual ultrasonic frequencies to generate the desired audio difference signal. However, this dual-frequency, ultrasonic signal was propagated from a gel medium on the face of the transducer, rather than through direct coupling of the transducer emitter face with air. This gel medium 20 “serves as a virtual acoustic source that produces the difference tone 23 whose frequency corresponds to the difference between frequencies f1 and f2.” Col 4, lines 54-60. In other words, this 1994 reference abandons direct generation of the difference audio signal in air from the face of the transducer. This abrupt shift from transducer/air interface to proposed use of a gel medium reinforces the perception of apparent inoperativeness of prior art disclosures, at least for practical speaker applications.

### OBJECTS AND SUMMARY OF THE INVENTION

It is an object of the present invention to provide a method and improved film transducer for indirectly emitting new audible acoustic waves at acceptable volume levels from a region of air without the use of conventional transducers as the ultrasonic frequency source.

It is another object to indirectly generate at least one new sonic or subsonic wave as parametric output having commercially acceptable volume levels by using a thin film emitter configured into arcuate emitter sections by closed-end cavities which maintain a permanent pressure differential with ambient air pressure.

It is still another object to provide a method for deforming a thin film speaker diaphragm within a pressure chamber into arcuate emitter sections capable of developing a uniform wave front across a broad ultrasonic emitter surface.

A still further object of this invention is to provide an improved speaker film diaphragm capable of being structured as a large parametric speaker transducer of six inches or more in diameter, with attendant high acoustic output comparable with modern dynamic speakers.

These objects are realized in a method of preparing a parametric speaker transducer for (i) generating sonic or subsonic audio output by propagating at least two frequencies having a difference in value equal to the desired sonic or subsonic audio output and (ii) decoupling the at least two frequencies to generate the desired audio output. The method comprises the steps of:

a. positioning an electrically sensitive, mechanically responsive film over at least one closed-end cavity of a rigid support member within a pressure chamber;

b. applying a pressure differential within the chamber to provide a common cavity pressure differential with respect to ambient pressure;

c. sealing the film to the support member while within the pressurized chamber to capture the cavity pressure differential in a permanent, sealed configuration; and

d. removing the sealed film and support member from the pressure chamber, thereby distending the film into an arcuate emitter configuration with respect to the at least one cavity in response to the pressure differential between cavity pressure and ambient pressure on opposing sides of the film to enable constricting and extending of the emitter configuration in response to variations in an applied electrical input at the piezoelectric film to thereby create a compression wave in a surrounding environment.

The invention can also be characterized as a speaker which includes a thin, piezoelectric membrane disposed over a common emitter face having at least one sealed, closed-end cavity having a negative cavity pressure differential captured within a vacuum chamber prior to exposure of the speaker to ambient air pressure. The membrane is drawn into an arcuate configuration and maintained in tension across the cavities by a near vacuum which is created within the pressure chamber and retained in a permanent sealed configuration within the cavity behind the emitter membrane.

A further embodiment of this invention is represented by a method of forming protuberances in piezoelectric material as a parametric emitter for an acoustic device wherein the method comprises the steps of:

a. providing a substrate having a plurality of closed-end cavities of a given dimension formed therein;

b. forming a laminate comprising a film of polymer piezoelectric material sandwiched between a first electrode layer on a top surface and a second electrode layer on a bottom surface;

c. positioning the substrate and the laminate within a low pressure environment;

d. securing the laminate to the substrate within the low pressure environment to form a sealed composite assembly which captures a low pressure state within the cavity between the substrate and the laminate; and

e. positioning the composite assembly in an ambient pressure environment to form protuberances in the film at the locations of the perforations.

The invention can also be viewed as a method for constructing a parametric piezoelectric emitter comprising:

a. providing an emitter substructure having at least one outer face having a plurality of closed-end cavities formed thereon;

b. providing a piezoelectric film with a first side and a second side with the film prepared to be adhered at the second side to the substructure outer face

c. placing the piezoelectric film and the emitter substructure in a vacuum chamber and substantially evacuating the air from the vacuum chamber;

d. bonding the piezoelectric film to at least one outer face of the substructure within the evacuated vacuum chamber to capture a low pressure condition in the cavity enclosed by the film and substructure; and

e. removing the substructure and bonded piezoelectric film to the external environment to allow atmospheric pressure to distend the piezoelectric thin film into concave arcuate configurations over the cavities.

From a structural point of view, the invention may be summarized as a parametric transducer apparatus comprising:

a substrate having an array of closed-end cavities including an open side respectively formed therein at predetermined positions on the substrate such that the array forms a given area within the substrate;

a layer of polymeric piezoelectric material disposed on the substrate to seal the open side of the cavities, the layer of piezoelectric material having a plurality of protuberances each being defined by a respective portion of the piezoelectric material extending into a corresponding one of the closed-end cavities, the plurality of protuberances being substantially permanently formed by a pressure differential existing between the sealed cavity and ambient room pressure and defining an active area of the transducer corresponding to the given area of the substrate; wherein a resonance frequency of the transducer is a function of a shape of the protuberances as determined by at least one dimension of the cavities, and wherein a vertical and horizontal beam angle associated with the transducer is controllable as a function of the dimensions of the active area of the transducer.

An additional perspective of the invention includes an ultrasonic transducer assembly comprising:

an ultrasound transducer including:

a substrate including top and bottom surfaces, the substrate formed of a conductive material and including a plurality of closed-end cavities formed therein;

a laminate comprising a film of a polymer piezoelectric material sandwiched between a first electrode layer on a top surface and a second electrode layer on a bottom surface, the laminate disposed on the top surface of the substrate, the laminate including a plurality of protuberances each of a given curvature and respectively extending into a corresponding one of the closed-end cavities based on a pressure differential existing between cavity pressure and ambient pressure; and

a housing containing the ultrasound transducer, the housing including an open end and a closed end, the housing comprising:

a first contact in electrical communication with the first electrode layer;

a second contact in electrical communication with the second electrode layer;

means coupled to the first contact for providing a first electrical connection to provide a first terminal for connection to a first electrical potential; and

means coupled to the second contact for providing a second electrical connection through the closed end to provide a second terminal for connection to a second electrical potential; whereby the substrate is operative to provide mechanical protection to the transducer laminate and to electrically couple the first and second electrode layers each to a corresponding terminal.

A further embodiment of the invention is a speaker device for emitting subsonic, sonic or ultrasonic compression waves, the device having a rigid emitter support member having an outer face that includes at least one closed-end cavity with a single exposed opening at the outer face of the support member. A thin piezoelectric film is disposed across and sealed to the outer face of the emitter support member, and the film is distended into an arcuate emitter configuration with respect to the at least one cavity in response to a pressure differential between cavity pressure and ambient pressure on opposing sides of the film. In this configuration, the film is capable of constricting and extending in response to variations in an applied electrical input to thereby create a compression wave in a surrounding environment.

Yet another embodiment is summarized as a speaker device for emitting subsonic, sonic or ultrasonic energy waves based on an emitter substructure having at least one outer face. The emitter substructure includes a plurality of closed-end cavities on the outer face of the emitter substructure with a thin piezoelectric film disposed across the cavities of the emitter plate in a substantially sealed off relationship relative to the external environment. Electrical contacts are coupled to the piezoelectric film for providing an applied electrical input. A pressure differential is applied between the configurations of cavities and the external environment for developing a biasing pressure with respect to the thin film at the cavities to distend the film into an emitter configuration with arcuate configurations capable of constricting and extending in response to variations in the applied electrical input at the piezoelectric film to thereby create an energy wave in a surrounding environment.

A still further embodiment of this invention includes a method for indirectly propagating parametric sound a predetermined distance as part of a parametric sound system. This method comprising the steps of:

a) selecting an approximate limiting distance for which parametric sound is to be propagated such that beyond the limiting distance sound pressure level is nominal;

b) identifying a maximum sound pressure level at which the parametric sound system is to be operated;

c) selecting an ultrasonic carrier frequency for the parametric sound system that is sufficiently high so that propagated ultrasonic output of the sound system is sufficiently attenuated within the selected limited distance to limit propagation of the parametric sound to nominal levels beyond the limiting distance; and

d) operating the parametric sound system at the selected ultrasonic carrier frequency and approximately at or below the identified maximum sound pressure level.

Other objects, features, advantages and alternative aspects of the present invention will become apparent to those skilled in the art from a consideration of the following detailed description, taken in combination with the accompanying drawings.

### BRIEF DESCRIPTION OF THE DRAWINGS

FIG. 1 is an elevational, partial cutaway view of an emitter transducer made in accordance with the principles of the present invention.

FIG. 2 is a top view of the support plate component of the transducer of FIG. 1 showing a plurality of cavities made in accordance with the principles of the present invention.

FIG. 3 is a cut-away profile view of the emitter transducer and the emitter face of FIG. 1, showing the membrane disposed over the cavities in the emitter face.

FIG. 4 is an exploded, perspective view of a transducer constructed in accordance with one embodiment of the present invention.

FIG. 5a is a close-up cross section of FIG. 1 showing several cavities with the membrane distended into a concave configuration by reason of a vacuum pressure differential within the cavities.

FIG. 5b is a close-up cross section of a second embodiment comparable to FIG. 5a, but showing the membrane distended into a convex configuration by reason of a positive pressure differential within the cavities.

FIG. 6a provides an elevational view of a fixture component for supporting a support plate having closed-end cavities in accordance with the present invention.

FIG. 6b an elevational view of a fixture component for supporting a emitting film membrane in accordance with the present invention.

FIG. 6c shows the respective fixture components of FIGS. 6a and 6b assembled for joining the film with the support plate.

FIG. 6d depicts an elevational view of a compression chamber with the fixture of FIG. 6c positioned on a support frame prior to decompression.

FIG. 7 is a graphic representation of a parametric implementation of the present invention that transmits an ultrasonic carrier frequency and an ultrasonic data frequency that acoustically heterodyne to generate a new sonic or subsonic frequency.

FIG. 8 is a top, plan view of a support member having an array of elongate cavities as configured in the embodiment of FIG. 7.

FIG. 9 provides an elevational graphic representation of an alternative embodiment of a support member having a serpentine cavity configuration.

FIG. 10 illustrates an alternative embodiment of the elongate cavities of FIG. 4 configured as a single cavity.

FIG. 11 provides an elevational graphic representation of an alternative embodiment of a support member having a concentric array of circular cavities.

FIG. 12 provides an elevational graphic representation of an alternative embodiment of a support member having a concentric array of semi-elliptical cavity configurations.

FIG. 13 is a top view of an emitter face with rectangular cavity openings.

FIG. 14 is a top view of an emitter face with ellipsoid cavity openings.

FIG. 15 is a cut-away profile view of an emitter with a convex emitter face.

FIG. 16 is a cut-away profile view of an emitter with a concave emitter face.

FIG. 17 is a cut-away profile view of an emitter with a convex emitter face, including an array of resonant pipes coupled to the piezoelectric film at the cavity boundaries on the emitter face.

FIG. 17a is a sectional top view of one array of the resonant pipes of FIG. 17.

FIG. 18 is a graphic representation of an additional embodiment of a support member configured with intermediate electrical contact ridges for applying signal voltage to the film emitter.

FIG. 19 is a top view of an emitter face having two semicircular electrical contacts.

FIG. 20 is a top view of an emitter face with four electrical contacts.

FIG. 21 is a top view of an emitter face with two concentric electrical contact rings.

FIG. 22 is a top view of an emitter face with three concentric electrical contact rings.

FIG. 23 illustrates a perspective, partial cutaway view of a dual-sided emitter configuration.

FIG. 24 is a graphic representation of emitter output comparing SPL with frequency, based on the embodiment of FIG. 4.

FIG. 25 depicts an emitter device in accordance with the present invention that includes a rear plenum structure as part of the closed-end cavity.

### DETAILED DESCRIPTION OF THE INVENTION

The traditional use of bimorph piezoelectric transducers in a parametric array as a speaker member embodies numerous limitations that have apparently discouraged practical applications of transducers within the audio and ultrasonic sound generation industries. Such limitations include lack of uniformity of phase and frequency response across a large array of individual transducers. Often, distortion, reduced output, and unintentional beam steering occur because of small variations in transducer resonant frequencies within the respective bimorph devices, as well as variable response to differing frequencies within a broad frequency spectrum. Many of these limitations arise because a typical speaker array is formed from many individual, non-uniform transducers respectively wired to a common signal source. Each transducer is somewhat unique and operates autonomously with respect to the other transducers in a parallel or series configuration.

The present invention develops congruity and uniformity across the array by providing a single film of piezoelectric or comparable material that is predictable in response to an applied signal across the full emitter face. This results, in large measure, because in a preferred embodiment the emitter is actually a single film of the same composition supported across a plurality of openings of common dimension. Furthermore, the full emitter face is physically integrated because the material is simply disposed across the emitter plate or disk and is activated by a single set of electrical contacts. Therefore, the array of individual emitting locations, represented by the respective openings in the emitter plate, are actually operating as a single emitter which is activated by the same electrical input. Arcuate distention of the film is uniform at each opening because the same material is being biased in tension across the same dimension by a common pressure (positive or negative). Harmonic and phase distortions are therefore minimized, facilitating a uniform wave front across the operable bandwidth.

Early embodiments of the present invention were filed as an initial parent patent application that matured into U.S. Pat. No. 6,011,855, disclosing the concept of using emitter film that deformed into arcuate emitter sections within open spaces extending into a support plate. By distending piezoelectric film into these openings in response to a vacuum or low pressure, the arcuate section was able to vibrate in accordance with an applied ultrasonic signal and emit ultrasonic sound waves. The required open spaces in the plate were originally developed by use of a plurality of apertures or holes that extended through the plate and into a plenum or other low-pressure chamber. Numerous prior art problems were overcome by this shift from bimorph transducers to a film emitter, particularly with a plurality of curved emitter sections on a single film surface.

Second and third parent patent applications (U.S. Ser. Nos. 09/388,787 and 09/478,114) provided additional focus on variations in embodiments of this type of film emitter. The use of apertures extending through the plate continued, and variations of aperture configuration were disclosed, including elongated slots and other geometries. Both positive and negative pressure differentials were applied to the film to develop convex and well as concave distention of the film. Here again, the film configuration provided a significant advancement in performance over prior art structures.

A significant challenge with respect to this improved emitter film configuration was maintaining a stable pressure differential on the film for a prolonged period of use. Obviously, such stability is essential to provide predictable performance with quality audio output. Various sealing techniques were disclosed in the parent patent applications for accomplishing this objective. Nevertheless, implementation of required sealing techniques and pressure stability resulted in a significant cost factor increase. Furthermore, pressure losses often resulted because valves and connection ports used to apply and maintain the low-pressure condition developed leaks that eventually compromised the operating system.

The current embodiment of the present invention provides a solution for maintaining the required pressure differential that is both inexpensive and highly effective. It allows the pressure differential applied to the film to be initially set during fabrication of the emitter, rather than requiring subsequent manual pressure adjustment. More importantly, it avoids the need for ports and values previously used to apply the desired pressure condition. The resulting pressure differential is preserved and the pressure differential remains stable over long periods of use.

The permanent pressure differential condition as compared to ambient pressure is accomplished by forming a closed-end cavity in the support plate, rather than by providing an aperture which is evacuated subsequent to sealing the film to the support plate. In the present invention, the pressure differential within the cavity is realized by sealing the film to the plate while the film and plate are positioned within a pressure chamber in which the pressure level is set to the desired pressure differential. By sealing the film to the cavity while at the controlled pressure differential, the pressure differential is permanently captured within the cavity, eliminating the need for subsequent evacuation. When the sealed film and support plate are removed to ambient surroundings, the pressure level captured in each cavity causes the film to distend and form the desired arcuate emitter section. The film application, sealing and pressure adjustment are all accomplished in a single step without the need for additional components or costly labor.

This surprisingly simple method for setting the correct pressure at the film to distend the required arcuate emitter sections is summarized by the following steps for emitting subsonic, sonic or ultrasonic compression waves. The basic procedure begins by positioning a piezoelectric or comparable film over at least one closed-end cavity within a rigid support member at an outer face formed around the at least one cavity. The film is then permanently sealed to the support plate within a pressure chamber that has been adjusted to a pressure differential relative to ambient pressure. Next, the film is distended into an arcuate emitter configuration with respect to the at least one cavity in response to the pressure differential between cavity pressure and ambient pressure on opposing sides of the film. This enables constricting and extending of the emitter configuration in response to variations in an applied electrical input at the piezoelectric film to thereby create a compression wave in a surrounding environment. The final step is applying electrical input to the piezoelectric film to propagate a desired compression wave.

Within the context of specifically forming the emitter section, the preferred procedure can be summarized by the following steps. The support member and the piezoelectric film are positioned within a chamber having a chamber pressure at a substantial pressure differential with respect to ambient pressure. The film is then sealed to the outer face of the support member while in the chamber to capture the chamber pressure within the at least one cavity. Finally, the support member and sealed film are removed from the chamber to an ambient pressure environment to thereby distend the film into the arcuate configuration with respect to the at least one cavity. Typically, a negative pressure such as a vacuum will be applied within the chamber, thereby creating a negative cavity pressure to distend the film into the arcuate configuration within the at least one cavity. These general procedures will be better understood based on the following examples and specific embodiments.

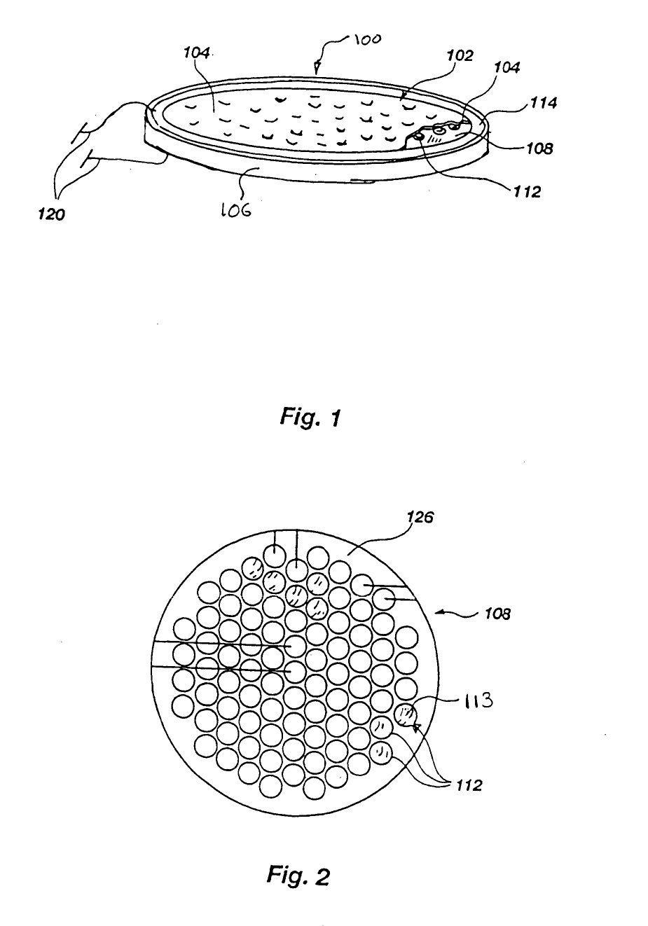

FIGS. 1, 2, and 3 depict one embodiment of the present invention shown in orthogonal, partial cutaway view. The emitter transducer 100 is generally a disk, plate, or similar solid object that has cavities 112 formed in one or both sides. The sidewall 106 of the emitter transducer 100 typically corresponds to the thickness of the plate and defines the perimeter boundary of the emitter device. The emitter face 102 generates the compression waves from the top surface of the emitter transducer 100 and is comprised of at least two components—the emitter film 104 and the face of the emitter plate or disk 108.

The outer surface of the emitter 102 is formed by the thin, piezoelectric film 104. This film 104 is supported by the rigid emitter plate 108 that includes a plurality of cavities 112 for enabling distention of the film into small arcuate emitter sections or elements. Such cavities comprise indentations into the body of the plate and are therefore referred to as closed-end cavities because the plate body forms a closed, interior side 113 that is visible through the cavity opening. The cavity openings generally coincide with the surface 126 of the plate.

As mentioned above, these emitter elements are typically uniform in all respects—size, curvature and composition where common resonance and performance features are desired. This commonality results in a common output across the face of the emitter film as if it were a single emitter element. As will be noted hereafter, variations in cavity shape may be applied to develop differing properties in audio output. For example, high and low resonant frequencies can be enhanced by small and large cavity shapes. Other variations will be apparent to those skilled in the art.

The piezoelectric film 104 is stimulated to emission by electrical signals applied through appropriate contacts 120 and 121 and is thereby caused to vibrate at desired frequencies to generate compression waves. A typical configuration of the film will include conductive surfaces at opposing sides that provide the voltage source to stimulate the film to contract and extend, propagating the resulting compression waves. This is facilitated by a conductive ring 114 coupled around the emitter plate or disk 108. The conductive ring is therefore positioned above the piezoelectric film 104 and disposed about the perimeter of the emitter face 102, and operates as both a clamp for a perimeter edge of the film and electrical signal source to contact 120 for the piezoelectric material. A second contact 121 couples to the opposing side of the film and is electrically isolated from the first contact 120.

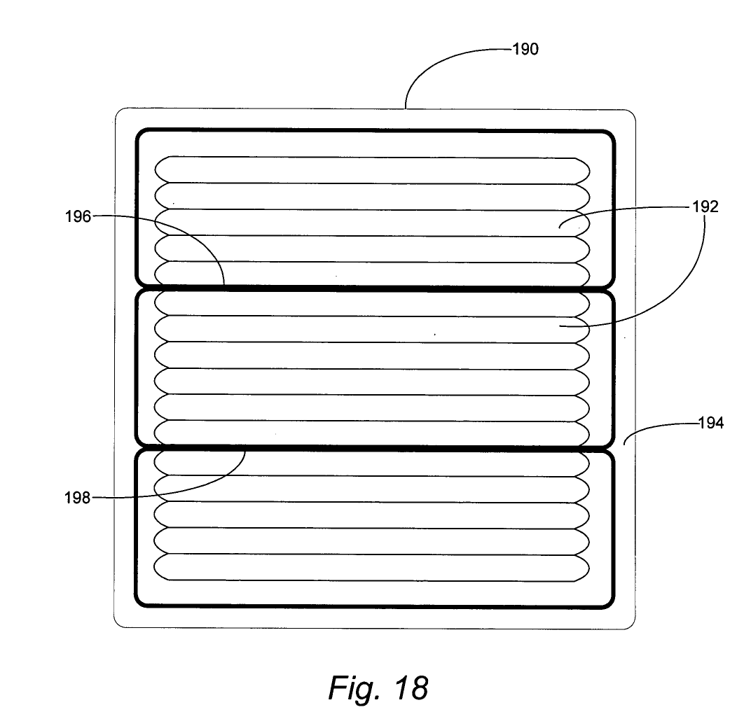

Typically, this conductive ring 114 is made of aluminum or brass. However, other electrically conductive materials could be utilized. The size of the conductive ring is based on the total surface area of the film. For small emitters, a single perimeter ring will likely be sufficient. If larger emitter structures (ie greater than 6 inches in diameter) are used, multiple contact structures may be required to provide proper impedance matching across the emitter face. An example of such structure using cross struts to facilitate voltage contact across sectors of the emitter film is shown in FIG. 18. This embodiment comprises a support plate 190 that is configured with a plurality of channel cavities 192. In this case, the emitter device measures approximately 12 inches square. As a consequence there is sufficient impedance across the extended width of the film that a significant voltage drop occurs toward a middle section of the film. In addition, a slight time delay may occur which could result in phase mismatch for the emitter sections of the film. This mismatch is overcome by positioning several cross ribs 196 and 198 across the support plate and providing them with a conductive layer to supply an applied electrical signal at both the conductive perimeter 194 and the intermediate conductive ribs 196 and 198. Such conductive rib structure can be formed as an integral part of the support plate by increasing the width of the rib structure separating the respective channels adjacent positions 196 and 198. It will be apparent that such contact ribs can be positioned at any strategic point necessary to provide uniform operation of the device. Other methods for supplying an electrical signal over intermediate sections of the emitter film will be apparent to those skilled in the art.

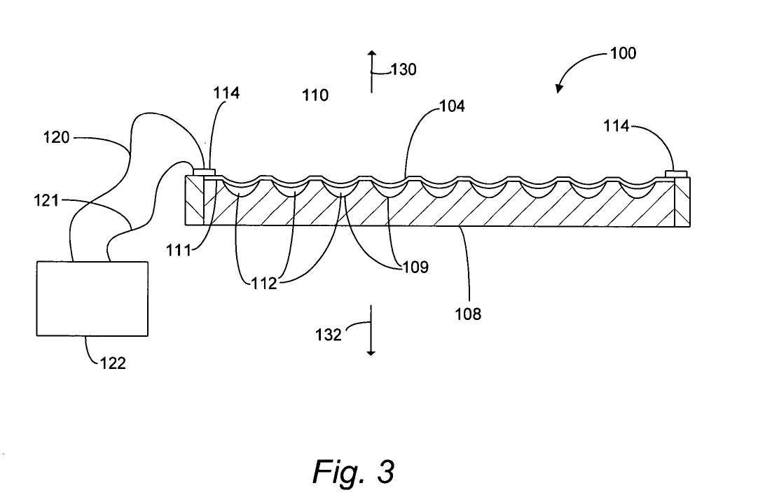

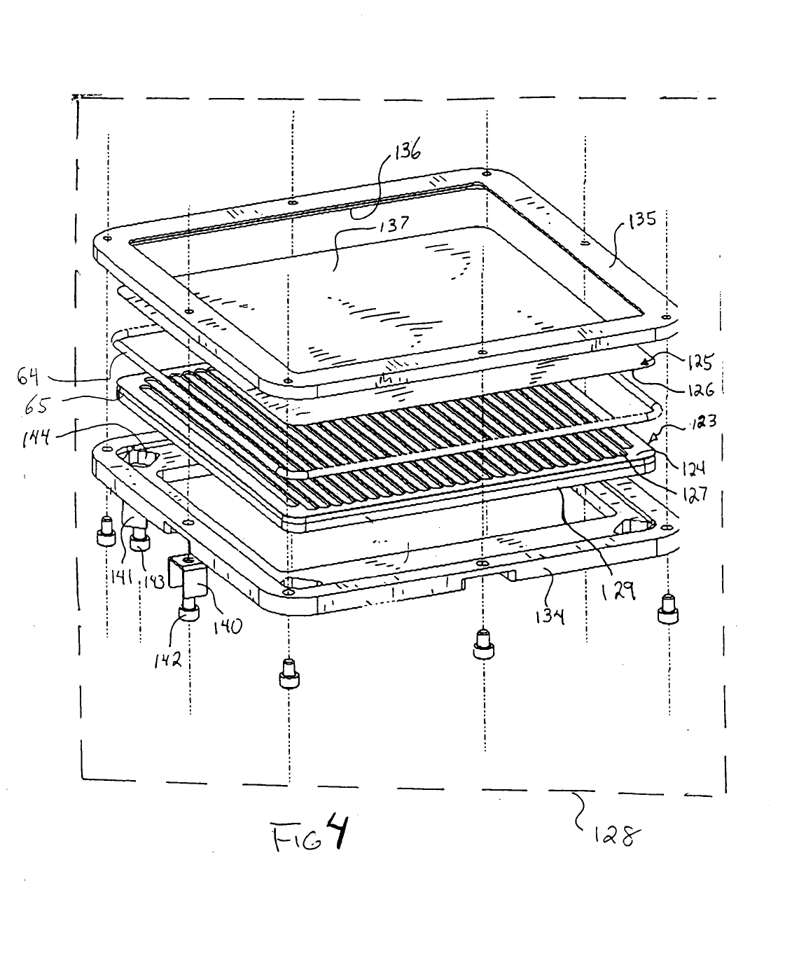

To better understand the structure of the emitter transducer 100, FIG. 2 provides a top view of face 126 of an isolated emitter disk 108 which is normally disposed underneath the piezoelectric film 104 (see FIG. 1). In one of the preferred embodiments, the disk 108 is metallic and structured with a plurality of cavities 112 of generally uniform dimensions. Other rigid materials may be used, such as plastics, ceramics, etc., provided appropriate conductive properties are applied to supply the electrical signal to the film. As previously mentioned, apertures as disclosed in the parent applications extended completely through the thickness of the disk from an inward facing side to the outward facing side (see FIG. 3a of parent patents). The cavities 112 of the preferred embodiment of the present invention extend only partially through the thickness of the disk 108 from the outward facing side 126. This forms a closed-end cavity that provides an exposed opening to be covered by the film. When covered, the cavity is fully closed and forms a void space between the film and cavity wall within the disk or plate.

The shapes of the cavities, as with the apertures in the parent applications, can vary. Specific shape configurations will be a function of desired resonant values, frequency response, material properties of the film, etc. The preferred embodiment of the present invention favors elongate shapes rather than cylindrical configurations, which surprisingly develop greater predictability and efficiency in performance. Nevertheless, assorted shapes and configurations may include, circular, oval, squared, rectangular, trapezoidal, triangular, and other curved and polygon configurations.

The pattern of cavities 112 shown on the disk 108 in FIG. 2 was chosen in this case because it enables the greatest number of cavities 112 to be located within a given area. The pattern is typically described as a “honeycomb” pattern. The honeycomb pattern may be selected when it is desirable to have a large number of cavities 112 in the emitter device. This cavity construction is more clearly shown in FIG. 3, which is a cross section of the transducer of FIG. 1. The respective cavities 112 are formed within the support plate 108 to have closed ends 109 within the plate and exposed openings 110 coincident with the face 111 of the plate. The film is drawn into each of the cavities in concave manner and becomes the emitting portion of the transducer.

FIG. 4 illustrates an improved version of the transducer in exploded view, depicting a cavity configuration that comprises elongated slots or channels. Specifically, the transducer comprises a support plate 123 that is conductive at its forward face 124 to enable application of a uniform voltage at the contacting bottom face 126 of the piezoelectric film 125. The support plate may be made of rigid metallic composition such as aluminum, copper and similar conductive metals, or it could be constructed of ceramic or polymer materials and coated with a conductive material at its forward face 124. Those skilled in the art will realize that numerous material configurations can be implemented to develop the desired cavity structure with a conductive interface at the film disposed thereon.

The cavities 127 are formed into the face of the support plate in a desired configuration by direct molding, tooling, or any other process that provides economy and predictable shape formation. The present embodiment illustrates an array of elongate channels or troughs 127 positioned in parallel relationship substantially across the complete surface 124 of the plate. Although the symmetry of circular shapes in the parent applications were originally thought to be preferred because of the compact honeycomb positioning and predicable response across any diagonal of the emitter surface, the elongated slot configuration has proven to be surprisingly more effective. Power output of the elongate configuration is substantially enhanced by several multiples over the previous circular shapes for the same plate dimensions by use of unidirectional film which is active along a transverse direction of the channels. Further discussion on alternative cavity configuration is discussed hereafter.

The emitter film 125 interacts with the cavity elements to deform into arcuate emitter elements that respond to an applied voltage signal to stimulate the piezoelectric film into constriction and extension for producing acoustic output. In the present invention, a preferred method of generating the required arcuate distention is accomplished by assembling the transducer portion 123 and 125 as illustrated in FIG. 4 within a pressure chamber, represented by phantom line 128. Although either positive or negative pressure may be applied, a vacuum chamber will be discussed as the preferred environment.

Specifically, the support plate 123 is positioned within the vacuum chamber 128 and is supported in an assembly fixture or harness that positions and properly aligns the film 125 with respect to the support plate. A suitable bonding agent such as Loctite™ is applied around the perimeter surface area 124 of the support plate, to be activated as a sealing agent between the film and support plate while the assembly is within the chamber. The assembly fixture should be designed so that clamping of the plate and film can be activated within the closed chamber at the appropriate time.

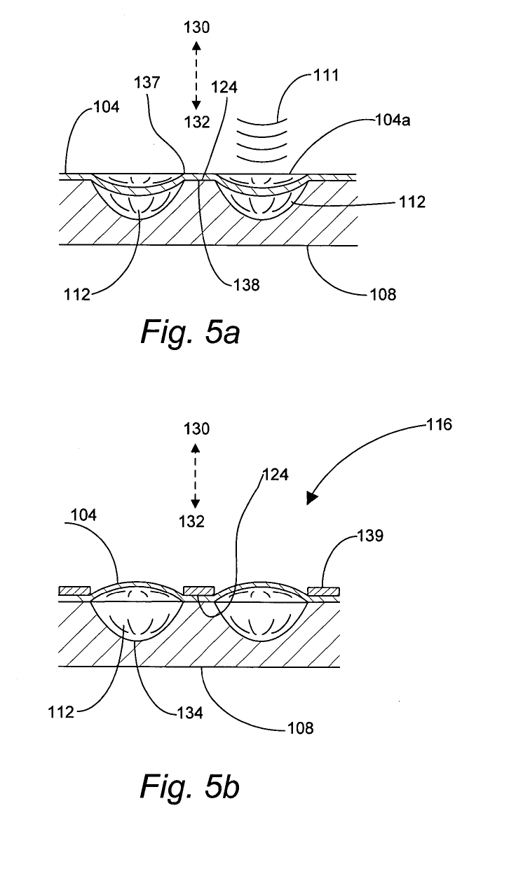

With the support plate and piezoelectric film secure within the assembly fixture and prepared for sealing, this transducer assembly is positioned within the vacuum chamber, The pressure is then reduced to near vacuum so that the pressure on both sides of the film (within and without the cavities) is at near vacuum. The film is then sealed to the face of the support plate with a permanent bond. Once the permanent seal is established, the pressure within the chamber can be equalized to ambient pressure. At this point the vacuum condition has been established within each cavity, resulting in distention of the film by the ambient pressure differential into the desired arcuate configuration as disclosed in FIG. 5a. If positive pressure had been applied within the chamber, the distention of the film would resemble that of FIG. 5b, having a convex, rather than concave configuration.

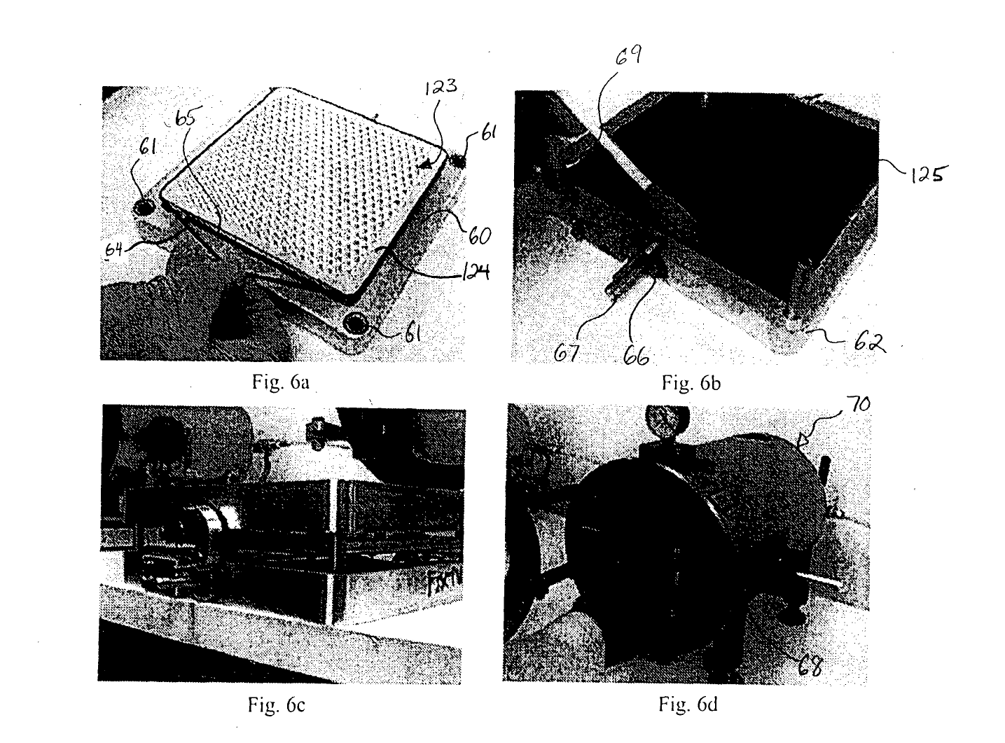

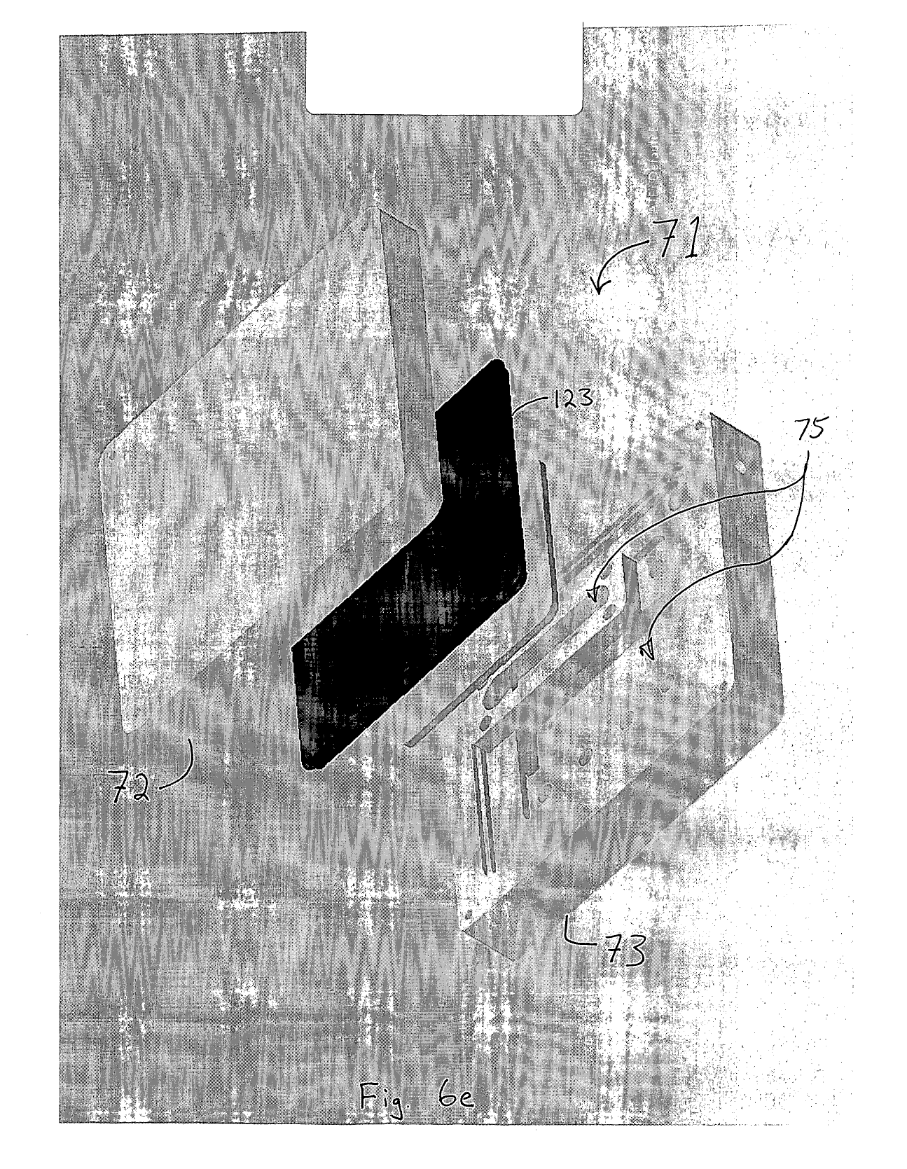

FIGS. 6a-6d illustrate one method for practicing the subject method of pressurization of the transducer as shown in FIG. 4. FIG. 6a depicts the emitter plate 123 positioned within a base support 60 that forms part of the fixture. Mounting openings 61 are provided at the corners of the base 60 to align this component with an upper member 62 that holds the film element 125. A gasket 64 is disposed around the support plate 123 in grove 65 to provide an insulating element between the opposing voltages on opposite sides of the film, positioning the edges of the film away from the support plate.

FIG. 6b shows the film on the upper fixture member 62 with a glue applicator 69 being applied to the periphery of the film. This periphery will be bonded to the outer edge 124 of the support plate while the device is within the pressure chamber. A spring-biased cam release 66 is coupled into the upper member and includes a tool 67 which can be operated from outside the chamber to release the opposing upper and base fixture members into compressive contact to bond the film and plate together.

FIG. 6c illustrates the upper and base components 62 and 60 assembled and aligned with the film secured in the upper member and the support plate in the lower member. At this point, the respective elements have been thoroughly cleaned and adhesive has been applied. The cam release is spring-loaded and will compress the two members into firm contact when the pressure chamber is suitably pressurized.

This fixture is next placed in the pressure chamber 70 as shown in FIG. 6d. A rack assembly 68 provides a stable support configuration for the fixture, which is then coupled to a control key (not shown) which extends through the door of the chamber and engages the cam release tool. Pressure is reduced to approximately 5 mm of Hg, and then the key is turned to release the fixture members to engage and seal the film to the support plate. The glue is allowed to cure, permanently capturing the vacuum state of the pressure chamber within the cavity space of the transducer. The transducer can then be mounted in the assembly as shown in FIG. 4.

FIG. 6e illustrates another method for practicing the subject method of pressurization of the transducer as shown in FIG. 4. The pressure chamber 71 in FIG. 6e consists of two plates 72 and 73 to enclose, support and secure the support plate 123 with the emitter film. In this embodiment, the pressure chamber has been tooled to minimal volume, making allowances for spaces 75 for movement of the necessary positioning hardware to attach the film to the support plate as explained herein. When large emitters (16″ or greater) are manufactured, it is often takes extended periods of time to evacuate the air from the volume of the large chamber required to hold such an emitter. When a transducer is placed within the narrow pressure chamber 71 of the present embodiment, the nominal volume of the pressure chamber enables a vacuum to be drawn between the film and the support plate 123 quickly as the film and the support plate come together. Because the vacuum is localized to the reduced area between the opposing cavity plates 72 and 73, the resultant vacuum evacuates the air almost instantaneously, whereas larger pressure chambers may take many seconds or minutes. An additional benefit of the pressure chamber 71 is that no additional structure size other than the plates 72 and 73 is required. Although the pressure chamber 71 is most beneficial for large emitters, the fixture is equally effective and applicable to smaller emitters.

The surprising simplicity of this preferred assembly procedure is notable. For example, the common vacuum environment within the chamber automatically equalizes all cavities to the same pressure. No pressure adjustments are required subsequent to sealing because no access to the cavities exists thereafter. Because exact pressure conditions can be controlled within the pressure chamber, a high level of accuracy is realized in pressure levels within the cavities. Once sealed, the emitter element is essentially self-contained for long term, permanent use. No valving structure is required as part of the emitter structure, reducing both cost and complexity.

The film remains stable in its arcuate shape because the vacuum pressure is fixed and the face of the rigid support plate restrains all of the film that is not disposed over one of the cavities. As a consequence, the vacuum draws the emitter section of the film into the cavity as shown in FIG. 5a, with a stable boundary edge 137 at each cavity being formed in the film at the rigid cavity edge of the support plate face 138. In contrast, the structure of FIG. 5b with positive pressure within the cavity would tend to urge the film 104 away from the face 124, potentially releasing the bond. Accordingly, a reinforcement plate 139 surrounding each cavity could be used to reinforce the boundary edge and bond where positive pressure is used.

An additional benefit of low pressure such as a vacuum is the elimination of any possibility of undesirable “back-wave” distortion. Elimination of the back-wave in the present invention arises from the presence of the vacuum in the sealed cavities. By definition, a compression wave requires that there be a compressible medium through which it can travel. If the piezoelectric film 104 can be caused to generate ultrasonic compression waves “outward” in the direction indicated by arrow 130 from the emitter transducer 100, it is only logical that ultrasonic compression waves are also being generated from the piezoelectric film 104 which will travel in an opposite direction, backwards into the emitter transducer 100 in the direction indicated by arrow 132.

In the absence of the vacuum condition, these backward traveling or back-wave distortion waves could interfere with the ability of the piezoelectric film 104 to generate desired frequencies. This interference could occur when the back-waves reflect off surfaces within the emitter transducer 100 until they again travel up through a cavity 112 and reflect off of the piezoelectric film 104, thus altering its vibrations. Therefore, by eliminating the medium for travel of compression waves (air) within the emitter transducer 100, reflective vibrations of the piezoelectric film 104 are eliminated.

FIG. 1 also shows that there are electrical leads 120 which are electrically coupled to the piezoelectric film 104 and which carry an electrical representation of the frequencies to be transmitted from each cavity cell of the emitter transducer 100. These electrical leads 120 are thus necessarily electrically coupled to some signal source 122 as shown.

The circuit for coupling the signal to the transducer is illustrated in greater detail in FIG. 4. The transducer assembly includes upper 135 and lower 134 frame components that enclose the sealed emitter assembly 123/125. The upper frame 135 is made of conductive metal, or at least has a conductive layer 136 coupled to its rearward face. The lower frame member 134 may be of plastic composition, or any other nonconductive material.

A signal is applied to the emitter assembly at opposing sides of the piezoelectric film through electrical contacts 140 and 141. Contact 140 comprises a conductive tab with a conductive bolt 142 that carries the signal to the upper frame member 135. This frame member 135 include a conductive face 136 that engages both the end of bolt 142 and the perimeter of the forward face 137 of the emitter film when fully secured together. Therefore, the signal is applied around the full perimeter of the upper conductive portion of film.

The opposing side 126 of the film is coupled to the signal through contact 141. A second conductive bolt 143 is electrically connected to the contact 141 and extends through an insulated port 144 to contact the lower side 129 of the transducer support plate. The remaining bolts 131 are merely to secure the assembly together as shown. Because the support plate is intimately bonded to the rearward side of the film with a conductive adhesive, the signal circuit is closed with the second contact 141. Obviously, the forward side 137 of the film must remain electrically insulated from the rearward side 126. This is accomplished in part by use of an O-ring 64 that is positioned in grove 65, forming an insulative barrier between the conductive support member and edge of the film. FIG. 5a illustrates the deflection of the film 104 into a concave, arcuate emitter section with the cavity 112. The undeflected portion of the film 104a remains flat against the face of the support member 108. Acoustic compression waves 111 are emitted forward 130 in a manner consistent with earlier embodiments of this invention. FIG. 5b illustrates the opposing, positive pressure embodiment in which the cavity 112 is set at positive pressure with respect to ambient surroundings. The film 104 is deflected into a convex configuration with respect to the support member 108. Reinforcement structure 139 is configured to surround each cavity and secure the film to the support plate as shown.

The membrane (piezoelectric film 104) used in this embodiment is a polyvinylidiene di-fluoride (PVDF) film of approximately 25 to 28 micrometers in thickness. Generally, film thickness for preferred embodiments of this invention will range between 9 to 90 microns. Experimentally, the resonant frequency of this particular emitter transducer 100 is shown to be approximately 37.23 kHz when using a drive voltage of 73.6 Vₚₚ, with a bandwidth of approximately 11.66 percent, where the upper and lower 6 dB frequencies are 35.55 kHz and 39.89 kHz respectively. The maximum amplitude of displacement of the piezoelectric film 104 was also found to be approximately just in excess of 1 micrometer peak to peak. This displacement corresponds to a sound pressure level (SPL hereinafter) of 125.4 dB.

What is surprising is that this large SPL was generated from an emitter transducer 100 using a PVDF which is theoretically supposed to withstand a drive voltage of 1680 V [symbol] , or 22.8 times more than what was applied. Consequently, the theoretical limit of these particular materials used in the emitter transducer 100 results in a surprisingly large SPL of 152.6 dB.

It is important to remember that the resonant frequency of the preferred embodiment shown herein is a function of various characteristics of the emitter transducer 100. These characteristics include, among other things, the thickness of the piezoelectric film 104 stretched across the emitter face 102, and the diameter of the cavities 112 in the emitter disk 108. For example, using a thinner piezoelectric film 104 will result in more rapid vibrations of the piezoelectric film 104 for a given applied voltage. Consequently, the resonant frequency of the emitter transducer 100 will be higher.

The advantage of a higher resonant frequency is that if the percentage of bandwidth remains at approximately 10 percent or increases as shown by experimental results, the desired range of frequencies can be easily generated. In other words, the range of human hearing is approximately 20 to 20,000 Hz. Therefore, if the bandwidth is wide enough to encompass at least 20,000 Hz, the entire range of human hearing can theoretically be generated as a new sonic wave as a result of acoustical heterodyning. Consequently, a signal with sonic intelligence modulated thereon, and which interferes with an appropriate carrier wave, will result in a new sonic signal which can generate audible sounds across the entire audible spectrum of human hearing. Practical applications to date have confirmed effective operating of the subject parametric emitter throughout the mid and high range of audio frequencies, based on cavity configurations illustrated in this application. Larger cavity sizes will produce a lower range of frequencies extending into the low audio bandwidths.

While some of the results have been explained, it is also useful to examine some of the equations which may be representative of the dynamics of the present invention. For a theoretical analysis of the film tensions and resonant frequencies please refer to the published works Vibrating Systems and their Equivalent Circuits by Zdenek Skvor, 1991 Elsevier, Marks Standard Handbook for Mechanical Engineers, Ninth Edition by Eugene A. Avallone and Theodore Baumeister III, and Theory of Plates and Shells by Stephen Timoshenko, 2nd edition. Marks' gives a very useful equation (5.4.34) which correlates tension in a membrane to resonant frequency. Resonant frequencies are a function of cavity shape, dimension, back pressure, film compliance and film density. Relationships between these values are complex and beyond the scope of this document.

It is important to recognize at this point that other types of piezoelectric films may be applied to the present invention. The important criteria are that the film be capable of (i) deforming into arcuate emitter sections at the cavity locations, and (ii) responding to an applied electrical signal to constrict and extend in a manner that reproduces an acoustic output corresponding to the signal content. Although piezoelectric materials are the primary materials that supply these design elements, new polymers are being developed that are technically not piezoelectric in nature. Nevertheless, the polymers are electrically sensitive and mechanically responsive in a manner similar to the traditional piezoelectric compositions. Accordingly, it should be understood that reference to piezoelectric films in this application is intended to extend to any suitable film that is both electrically sensitive and mechanically responsive (ESMR) so that acoustic waves can be realized in the subject transducer.

The pressure introduced within the cavity of the emitter transducer 116 can be varied to alter the resonant frequency. However, the thickness of the piezoelectric film 104 remains a key factor in determining how much pressure can be applied. This can be attributed in part to those piezoelectric films made from some copolymers having considerable anisotropy, instead of biaxially stretched PVDF used in the preferred embodiment. The undesirable side affect of an anisotropic piezoelectric film was noted in previous embodiments as a potential basis for preventing uniform vibration of the film in all directions, resulting in asymmetries and unwanted distortion of the signal. Consequently, PVDF was the preferred material for the piezoelectric film not only because it has a considerably higher yield strength than copolymer, but because it was considerably less anisotropic.

In the present embodiment having elongated channels as cavities, a biaxial or unidirectional film may used in which the ESMR properties are stronger across the narrow width of the channel, as opposed to along its length. In other words, the greatest constriction of the film occurs across the cavity width so that maximum acoustic output is realized. Indeed, a comparison of the elongate cavities with previous circular shapes for the emitter sections of the film in prior embodiments reveals a four to ten fold improvement in sound pressure levels, due in part to the weighted response of the piezoelectric film across the narrow width of the cavity. This benefit of enhanced acoustic output associated with a channel cavity configuration as opposed to circular or symmetrical shapes is carried forward into numerous alternative transducer embodiments as follows.

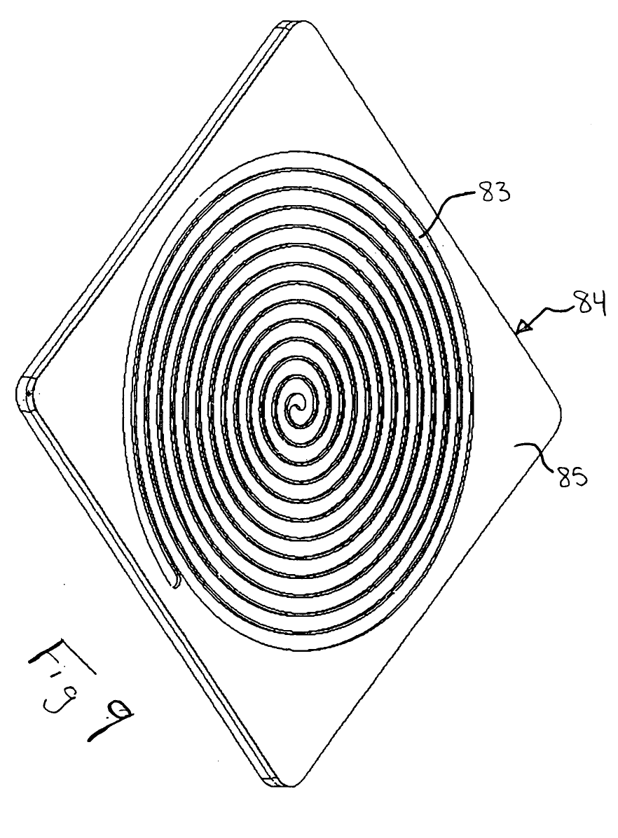

FIG. 8 shows a top view of the support plate 123 of the preferred embodiment of FIG. 4. The plate length L is approximately five inches square and 0.2 inches thick. A perimeter surface width P of approximately 0.2 inches provides the primary contact and sealing surface for the film at the face of the support plate. The channel lengths extend about 4.6 inches. Typically, the conductive surface of the film is in electrical contact with the perimeter surface of the support member and receives the signal voltage uniformly across its conductive area. Where film dimensions exceed 6×6 inches, additional conductive ribs across intermediate sections of the film may be required. This may be necessary for impedance matching across the film as is discussed hereafter.

FIG. 9 illustrates a serpentine configuration for the cavity structure. In this instance, a single cavity 83 is formed in the support plate 84 and implements the comparable design configuration of multiple elongate cavities. In this case, the perimeter surface area 85 includes a conductive medium to enable coupling of the electrical signal to the film.

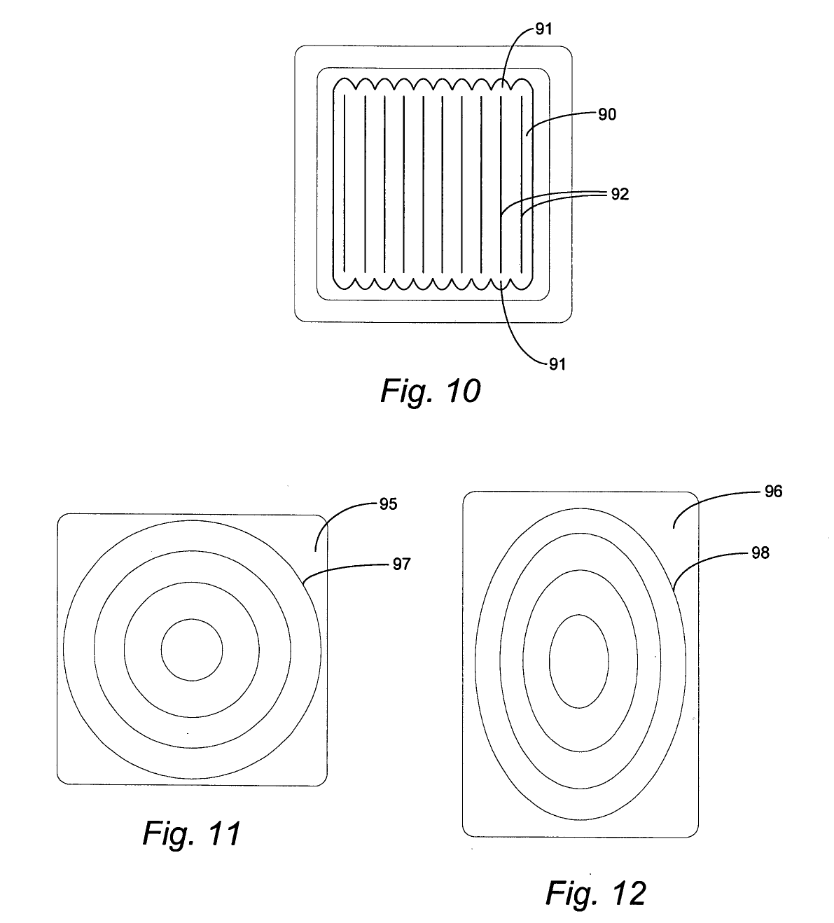

Similarly, a configuration such as is illustrated in FIG. 10 wherein the parallel channels of FIG. 4 are configured as a single, continuous channel 90 with open terminal ends 91 aperates similarly with the serpentine configuration. In FIG. 10, the channels retain their approximate same dimensions, except for opposing terminal ends of each cavity. In this latter embodiment, the separating ribs 92 have been displaced one-half channel width to position them along the center axis of each channel. In this manner, the cavity wraps around each separating rib on opposing ends to provide a continuous cavity channel path from one side to the other. In essence, both the serpentine configuration of FIG. 9 and the parallel continuous channel of FIG. 10 comprise single cavity systems wherein the cavity component is formed by a continuous channel structure.

A further configuration of the closed-end channel structure of the present invention is represented by the circular and elliptical rings of FIGS. 11 and 12. In these embodiments, the respective support plates 95 and 96 are provided with concentric ring channels 97 and elliptical channels 98. These channels are structured similarly with the elongate channels of FIG. 4, except for their curved shapes. It will be apparent to those skilled in the art that other geometries can be applied to implement the principles of the present invention.

From this perspective, a general statement of the present invention can be summarized as a speaker device for emitting subsonic, sonic or ultrasonic compression waves, wherein the device comprises rigid emitter support member having an outer face that includes at least one closed-end cavity with a single exposed opening at the outer face of the support member; and a thin piezoelectric or other ESMR film disposed across and sealed to the outer face of the emitter support member, the film being distended into an arcuate emitter configuration with respect to the at least one cavity in response to a pressure differential between cavity pressure and ambient pressure on opposing sides of the film. In this configuration, the film is capable of constricting and extending in response to variations in an applied electrical input to thereby create a compression wave in a surrounding environment.

Similar variations can be employed in the positive pressure embodiment as previously suggested with respect to FIG. 5b. This is accomplished by pressurizing the chamber prior to sealing the film to the support plate, in a manner similar to the use of a negative, vacuum pressure for the preferred embodiment. One aspect of the alternative embodiment of a pressurized emitter transducer 116 can be the occurrence of frequency resonances or spurs. This is due to back-wave generation within the emitter transducer 116, which arise from wave generation in the gas within the emitter transducer 116. However, it was also determined that the back-wave could be eliminated by placing a material within the emitter cavities 116 to absorb the back-waves. For example, a piece of foam rubber 134 or other acoustically absorbent or dampening material placed at the back wall or closed end of the cavity can generally eliminate all frequency spurs.

The preferred thickness of the piezoelectric film, the cavity size, and the cavity pressure will now be discussed. When the pressure differential is increased, it increases the resonant frequency of the speaker. The resonant frequency can also be increased by decreasing the cavity diameter or increasing the thickness of the piezoelectric film. The following table shows some preferred film thicknesses, cavity diameters and pressures to provide a resonant frequency of 35 kHz. These specific parameters provide the greatest output for the current invention. It should be apparent that a number of combinations could be used which fall within or near these ranges.

TABLE 1

| Film Thickness | Cavity Diameter | Pressure |
|---|---|---|
| 9 micrometers | 0.160 inches | 5 PSI |
| 12 micrometers | 0.168 inches | 6 PSI |
| 25 micrometers | 0.200 inches | 12 PSI |

Although Table 1 lists selected cavity sizes, the preferred cavity sizes fall in the range of 0.050 inches to 0.600 inches. The parameters listed in Table 1 are primarily focused on ultrasonic transducers. The actual performance of the film depends on different factors, such as whether the film is biaxial, uniaxial, or coated, etc. For example, a 9 micrometer film used at 5 PSI generates a resonant frequency of 35 kHz with a 0.160 inch cavity. In contrast, another 9 micrometer film covered with PVDC coating must have a 0.600 inch cavity at 5 PSI to produce the same 35 kHz resonant frequency. Although the previous examples of cavity sizes are directed to ultrasonic embodiments of the invention, larger holes can be used to directly produce useful sonic frequencies.

The spacing between the cavity centers is preferred to be between 1/4 to 1/2 of a wavelength (1/4 to ½ wL) of a carrier wave frequency, which is targeted for the maximum output. The preferred spacing between the cavity centers is 1/3 the wavelength of a carrier wave frequency, where the maximum output is desired.

A further favorable aspect of the present invention is the adaptability of the shape of the sonic emitter to specific applications. For example, any shape of can be configured, provided the thin piezoelectric film can be maintained in uniform tension across the disk face. This design feature permits speaker configurations to be fabricated in designer shapes that provide a unique decor to a room or other setting. Because of the nominal space requirements, a speaker of less than an inch in thickness can fabricated, using perimeter shapes that fit in corners, between columns, as part of wall-units having supporting high fidelity equipment, etc. Uniformity of tension of the emitter film across irregular shapes can be accomplished by stretching the film in a plane in an isotropic manner, and gluing the film at the intermediate rib faces, as well as the perimeter of the disk face.

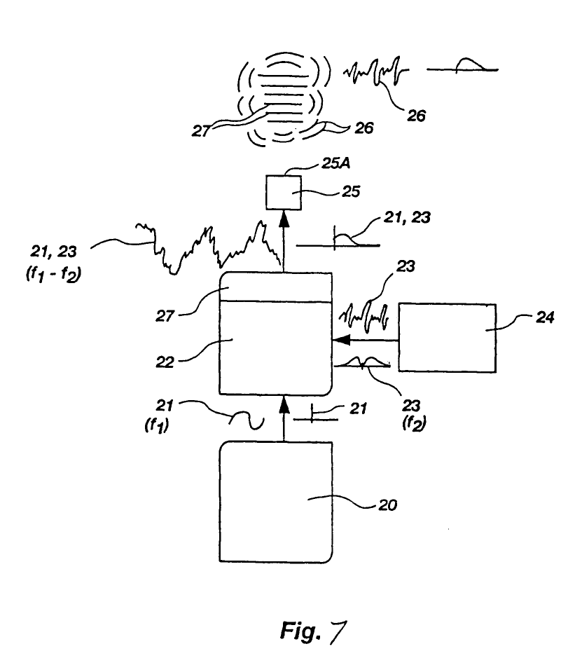

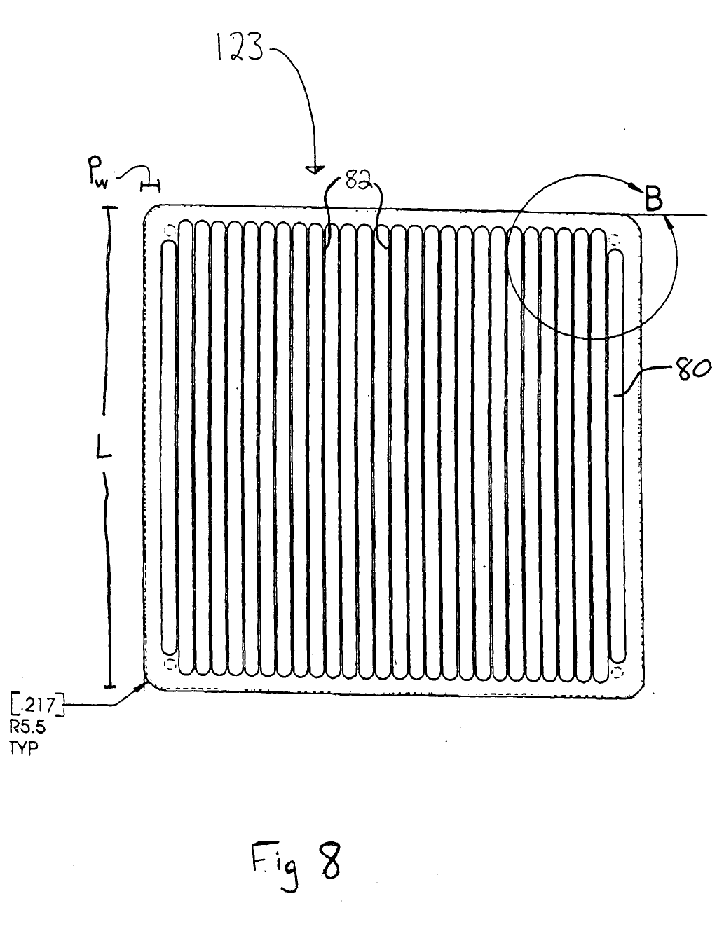

Turning to a more specific implementation of the preferred embodiment of the present invention, the emitter transducer 100 can be included in the parametric sound system shown in FIG. 7. This application utilizes a parametric or heterodyning technology, which is particularly adapted for the present thin film structure. The thin, piezoelectric film is well suited for operation at high ultrasonic frequencies in accordance with parametric speaker theory.

A basic system includes an oscillator or digital ultrasonic wave source 20 for providing a base or carrier wave 21. This wave 21 is generally referred to as a first ultrasonic wave or primary wave. An amplitude modulating component 22 is coupled to the output of the ultrasonic generator 20 and receives the base frequency 21 for mixing with a sonic or subsonic input signal 23. The sonic or subsonic signal may be supplied in either analog or digital form, and could be music from any convention signal source 24 or other form of sound. If the input signal 23 includes upper and lower sidebands, a filter component may included in the modulator to yield a single sideband output on the modulated carrier frequency for selected bandwidths.

The emitter transducer is shown as item 25, which is caused to emit the ultrasonic frequencies f₁ and f₂ as a new wave form propagated at the face of the thin film transducer 25a. This new wave form interacts within the nonlinear medium of air to generate the difference frequency 26, as a new sonic or subsonic wave. The ability to have large quantities of emitter elements formed in an emitter disk is particularly well suited for generation of a uniform wave front which can propagate quality audio output and meaningful volumes.

The present invention is able to function as described because the compression waves corresponding to f₁ and f₂ interfere in air according to the principles of acoustical heterodyning. Acoustical heterodyning is somewhat of a mechanical counterpart to the electrical heterodyning effect which takes place in a non-linear circuit. For example, amplitude modulation in an electrical circuit is a heterodyning process. The heterodyne process itself is simply the creation of two new waves. The new waves are the sum and the difference of two fundamental waves.

In acoustical heterodyning, the new waves equaling the sum and difference of the fundamental waves are observed to occur when at least two ultrasonic compression waves interact or interfere in air. The preferred transmission medium of the present invention is air because it is a highly compressible medium that responds non-linearly under different conditions. This non-linearity of air enables the heterodyning process to take place, decoupling the difference signal from the ultrasonic output. However, it should be remembered that any compressible fluid can function as the transmission medium if desired.

Whereas successful generation of a parametric difference wave in the prior art appears to have had only nominal audio volume, the present configuration generates full sound which offers commercial applications. While a single transducer carrying the AM modulated base frequency was able to project sound at considerable distances and impressive volume levels, the combination of a plurality of co-linear signals significantly increased the volume. When directed at a wall or other reflective surface, the volume was so substantial and directional that it reflected as if the wall were the very source of the sound generation.

An important feature of the present invention is that the base frequency and single or double sidebands are propagated from the same transducer face. Therefore, the component waves are perfectly collimated. Furthermore, phase alignment is at maximum, providing the highest level of interference possible between two different ultrasonic frequencies. With maximum interference insured between these waves, one achieves the greatest energy transfer to the air molecules, which effectively become the “speaker” radiating element in a parametric speaker. Accordingly, the inventors believe the enhancement of these factors within a thin film, ultrasonic emitter array as provided in the present invention has developed a surprising increase in volume to the audio output signal.

Recent developments by present inventors have developed a classification of both near-field and far-field design parameters for parametric speakers. For example, near-field applications focus on environments where the sound to be generated is localized, such as with convention booths, shopping isles, single computer stations and other circumstances where only one or several listeners are expected, and at short distances from the emitter device. In this instance, high ultrasonic frequencies will be preferred to minimize the propagation distance of the ultrasonic carrier waves, as well as the resultant audio output. Such frequencies would generally be above 60 KHz, and ideally at 60 to 80 KHz. Actual propagation parameters would be controlled by the desired maximum SPL levels in the location or distance anticipated by the position of the listener. For example, a user seated at a computer or in a surround sound setting for a home theater will likely be a predetermined positions dictated by the seating configuration with respect to the sound source. Propagation distances and SPL levels can be optimized to realize the maximum listening levels for these specific distances and locations. This is true because of the highly directional nature of parametric output, enabling control of the sound column along its propagation orientation.

The second classification of far-field applications utilizes a lower range of ultrasonic frequencies such as 30 KHz to 60 KHz, taking advantage of the enhanced propagation of the lower frequencies over greater distances. Specifically, ultrasonic frequencies in the 30 KHz to 40 KHz range will project up to three and four times the length of frequencies in the 60 to 80 KHz range. This extended length allows the production of audio output to generate a strong column of sound which is then able to propagate great distances with greater divergence. Far-field applications generally are applied with respect to reflective surfaces, generating virtual speakers as disclosed in prior applications of the present inventors (U.S. Pat. No. 6,229,899). Accordingly, near-field applications of parametric sound systems may be characterized as direct exposure systems, whereas far-field applications tend to fall within the category of indirect or virtual speaker systems.

The development of full volume capacity in a parametric speaker provides significant advantages over conventional speaker systems. Most important is the fact that sound is reproduced from a relatively massless radiating element. Specifically, there is no radiating element operating within the audio range, because the piezoelectric film is vibrating at ultrasonic frequencies. This feature of parametric sound generation by acoustical heterodyning can substantially eliminate conventional distortion effects, most of which are caused by the radiating element of a conventional speaker. For example, adverse harmonics and standing waves on the loudspeaker cone, cone overshoot and cone undershoot are substantially eliminated because the low mass, thin film is traversing distances in micrometers.

Low range ultrasonic frequencies for the present invention generally fall within the range of 25 KHz to 60 KHz. It has also been discovered that using higher frequency ranges of 60 KHz and greater for the carrier signal can be implemented by pretensioning the film prior to attachment of the film to the support plate. If uniaxial film is used, the film can be placed in tension across the width of the channels and along the uniaxial orientation of electro-mechanical displacement. Biaxial film may also be used where the strongest electro-mechanical response is applied transverse to the channel configurations. The pre-tensioning of film can be accomplished with a fixture and mounting structure as disclosed in an earlier U.S. patent by inventor James Croft.

With an enhanced tension applied while residing in the pressure chamber, the film becomes prestressed without initiation of the pressure differential previously discussed. When the emitter is removed to ambient pressure, the film tension is further enhanced by displacement of the respective emitter sections with respective to the cavities. Because the film is pre-stressed, the extent of deflection of the emitter portions of the film is somewhat less than with the untensioned film. This higher degree of tension enables operation at higher frequencies of 60 KHz and higher.

Such high range emitters are particularly useful in direct exposure parametric speaker systems where the range of audio projection is to be restricted to short distances. As mentioned earlier, this occurs because the higher frequency ranges of ultrasonic emissions attenuate much more rapidly in air. In this manner, a parametric speaker can be designed to develop predetermined projection ranges, based on selection of higher ultrasonic carrier frequencies which provide proper attenuation characteristics. The following formula provides an approximation to the parametric characteristics of SPL and carrier frequency needed to realize a predetermined propagation distance in feet.

This technique for controlling the region in which sound can be heard at restricted, preselected distances is summarized by the following description of a method for indirectly propagating parametric sound a predetermined distance as part of a parametric sound system. The method comprises the steps of:

a) selecting an approximate limiting distance for which parametric sound is to be propagated such that beyond the limiting distance sound pressure level is nominal;

b) identifying a maximum sound pressure level at which the parametric sound system is to be operated;

c) selecting an ultrasonic carrier frequency for the parametric sound system that is sufficiently high so that propagated ultrasonic output of the sound system is sufficiently attenuated within the selected limited distance to limit propagation of the parametric sound to nominal levels beyond the limiting distance; and

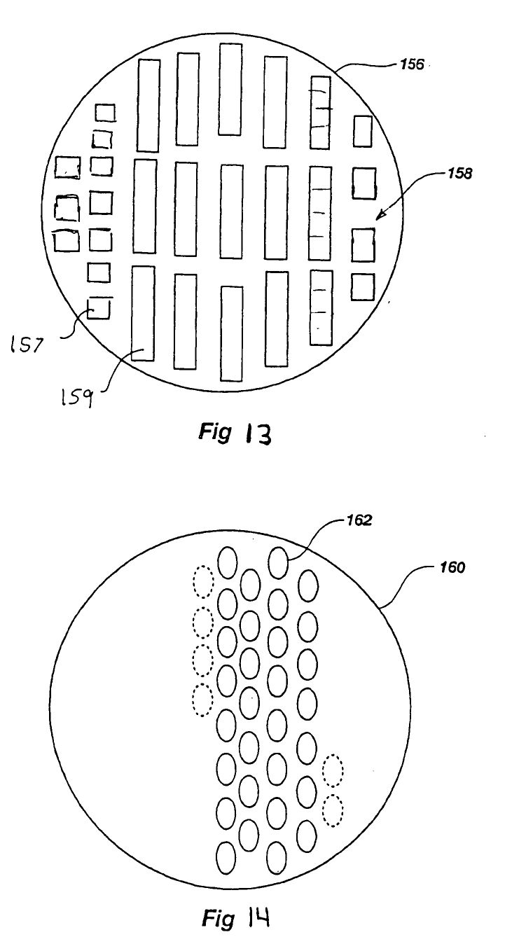

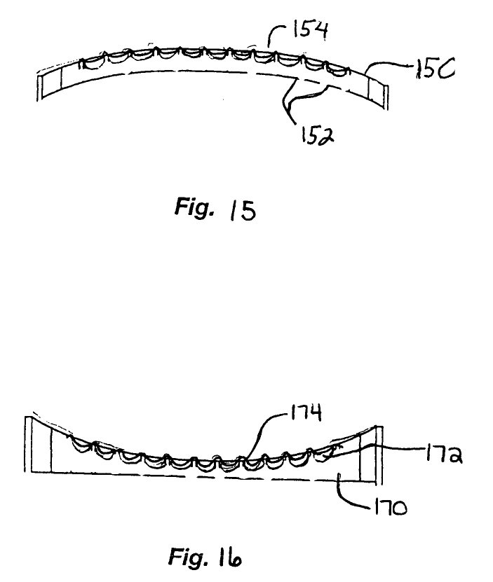

d) operating the parametric sound system at the selected ultrasonic carrier frequency and approximately at or below the identified sound pressure level.

Whereas the foregoing discussion has focused on one of the preferred embodiments of the present invention, we now return to previous embodiments and related characteristics which can also be applied to the present invention. For example, other embodiments of this invention may use cavities that do not extend the full length of the support plate, such as those disclosed in the parent applications. FIG. 13 shows a rigid emitter plate 156 which uses multiple rectangular shaped cavities 158 along each column of the speaker. Smaller cavities 157 can be positioned for developing higher frequency emissions, while larger cavities 159 are provided to extend audio output into the mid range frequencies. These smaller cavity structures can readily be implemented in accordance with the present inventive techniques herein disclosed.

FIG. 14 shows a rigid emitter plate 160 which has ellipsoid 162 shaped cavities. The properties of such shapes were discussed in the parent patent applications and need not be rehearsed again. These rectangular and ellipsoid shapes are particularly effective with an anisotropic or uniaxial film. This is because an effective wave can be generated when the piezoelectric film constricts or expands perpendicular to the lengthwise axis of the rectangle or ellipse. By focusing substantially all of the electro-mechanical responses at the shorter width of the channels, maximum SPL is achieved.

FIG. 15 is an embodiment of the speaker with a convex emitter plate. The convex support plate 150 is provided with an array of cavities 152 of selected resonant frequencies. The emitter film 154 is applied in accordance with the present invention, capturing the pressure differential within the cavities while in a pressure chamber. The convex shape of the emitter allows the sound generated to be dispersed over a broader area than the flat faced embodiment. As the curve in the emitter face increases, the dispersion also increases.

In contrast, FIG. 16 shows a concave emitter plate which focuses the directivity of the speaker. FIG. 16 has a concave emitter plate 170 for focusing the sound generated by the emitter cavity cells 172 at a predetermined point of maximum SPL level. This system can be particularly useful to assist in localizing parametric systems for direct, limited listener exposure. The film 174 is applied as previously disclosed for the convex and flat configurations.

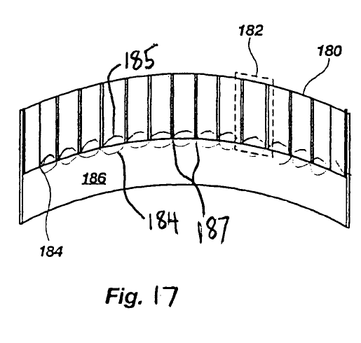

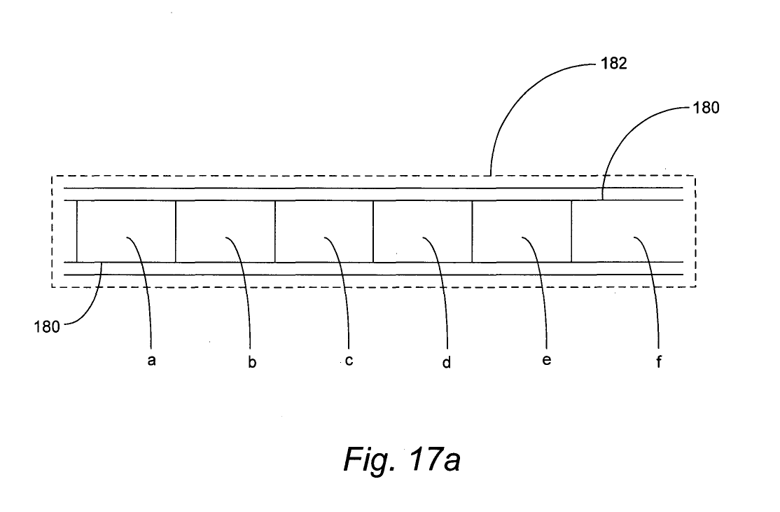

FIG. 17 illustrates the use of resonant tubes at the emitting sections of the diaphragm or film. Specifically, an array of tubes 180 is positioned in front of the emitting channel structures 184 with extended emitter film 185. In this embodiment, positive pressure has been established within the cavities from the pressure chamber. The rear edges 187 of the resonant tubes 180 are structured to abut at the forward edges of the respective cavities 184 so that the nonemitting portions of the film are rigidly captured between the tubes and the support plate. This contact corresponds to the contact of plate 139 in FIG. 5b. By configuring the tubes with appropriate multiples of the desired ultrasonic wavelength, enhanced resonance output of the emitter energy is accomplished.

If desired, the tubes can be subdivided into a parallel array of smaller tubes extending along the length of the elongate cavity channels illustrated in FIG. 4. This configuration is shown in FIG. 17a, wherein a single channel/tube combination 182 has been represented in top view, showing the respective divided sectors a, b, c, d, and e extending along the full tube length 180.

One of the advantages of the present invention is the uniform, in-phase sound propagation developed by applying a single signal across the total film surface of the emitter. In yet another embodiment of the invention, the electrodes on the emitter plate are not a complete ring and actually involve application of several different signal sources on the same emitter. FIG. 19 shows an emitter face 200 with two electrical contacts which are semi-circles. The first electrical contact 201 and the second electrical contact 202 can have separate signals applied to them. This allows regions of the piezoelectric film to be controlled independently. The signals applied to the different electrical contacts may be phase shifted, which produces corresponding waves in the air which are phase shifted. When these adjacent phase shifted waves interact at the ultrasonic level, it alters the directional path of the waves. By providing the proper phase relationships, the sound beam can be “steered” without physically moving the speaker. This provides the effect of movement for a user. In addition, multiple channels may also be applied through the separate electrical contacts 204,206. It will be apparent that an insulative barrier 208 will be required on the conductive, contacting side of the emitter film which is applied over the support plate 200 and cavities 203. In this manner, the right and left sections of the emitter are fully independent.

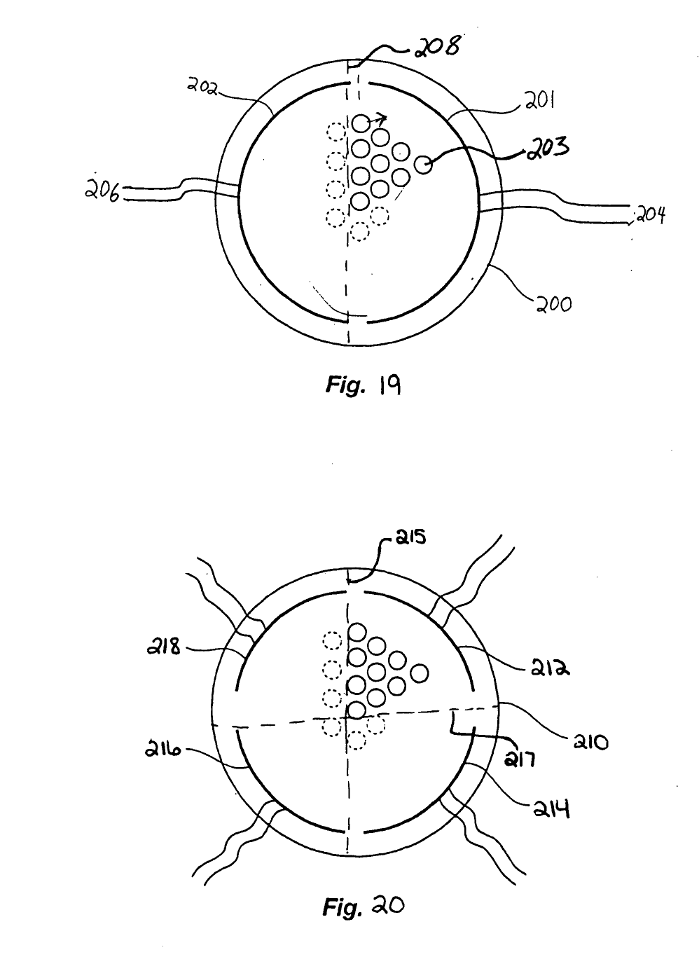

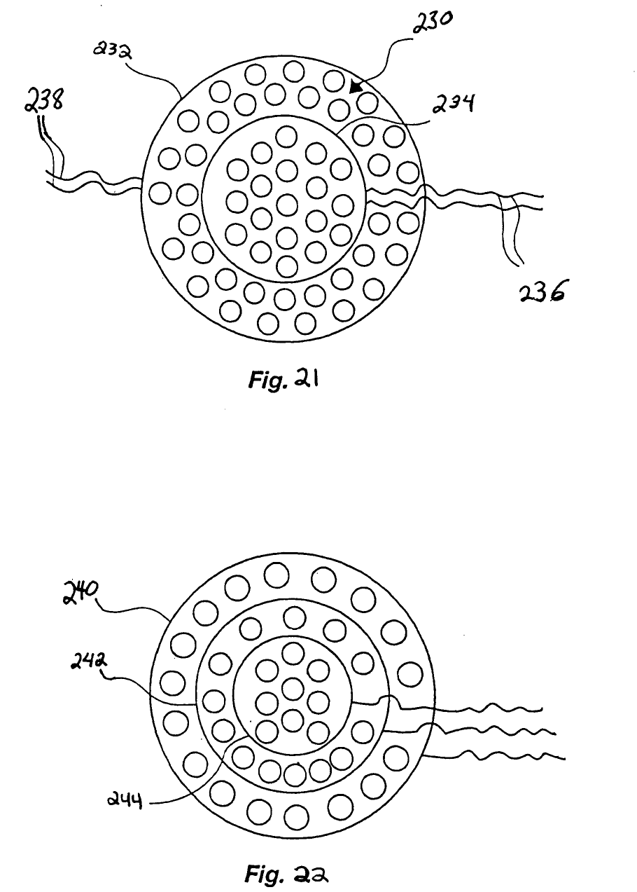

FIG. 20 shows an emitter face 210 with four electrical contacts 212, 214, 216, 218. Here again, the emitter film should be divided by insulating bands 215 and 217 to form corresponding four quarters of the emitter corresponding to the four electrical contacts. Although only four contacts are shown, the number of contacts is only limited by the size and number of regions that are desired to be controlled. The more electrical contacts which are manufactured on the emitter face, the greater the control of the separate piezoelectric regions. Each separate cell may even have its own electrical contacts. It should also be realized that a nearly unlimited number of contact arrangements are possible based on conventional electrode sputtering or flowing techniques.

Two other important embodiments using spatially arranged electrical contacts on piezoelectric film are shown in FIGS. 21 and 22. FIG. 21 shows a piezoelectric film 230 with two concentric electrical contact rings 232, 234. In the preferred implementation, the center ring 234 would contain approximately 1/2 of the total circle area and the second electrical contact would circumscribe the whole circle 234. The two electrical rings can each receive separate electrical signals from the wires 238 and 236. The signals may be phase shifted to create beam steering or spatial sound orientation. In addition, a separate channel can be used for each electrode. For example, one channel can be sent to the central ring such as a voice channel, and then a second channel can be sent to the second ring such as environmental background sounds. Essentially, the voice channel and the background channel in this example are spatially mixed on the piezoelectric film. FIG. 22 shows an alternative arrangement of an electrical contact embodiment with three electrical contacts 240, 242, 244. Additional contacts increase the control that can be exerted on the piezoelectric film.

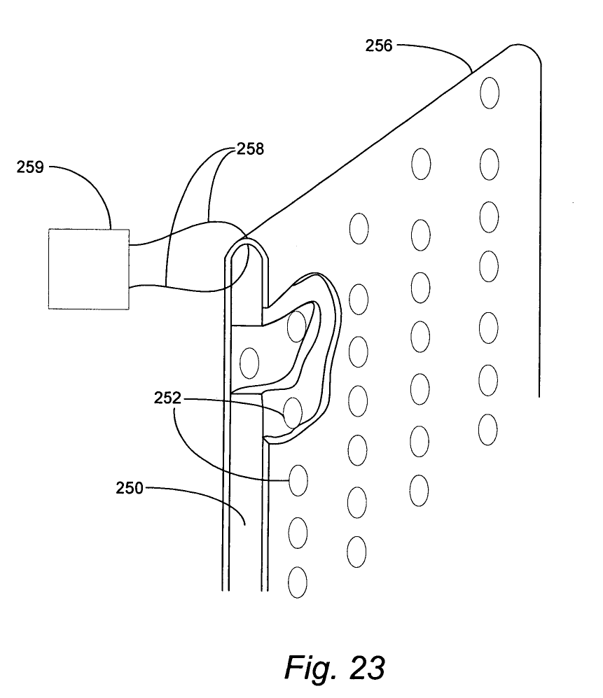

An additional alternate embodiment is illustrated in FIG. 23. This structure includes a support plate 250 having cavities 252 formed on opposing sides to enable propagation of the acoustic output in opposing directions. The same construction as previously outlined applies here, except that the film 256 is applied to both sides of the support plate 250, along with the operating signal. A single sheet of film may be wrapped 256 around the plate as illustrated, or two separate sheets can be applied. With the wrapped version, the electrical signal source 259 is coupled through contacts 258 at an intermediate location between the respective halves of the emitter.

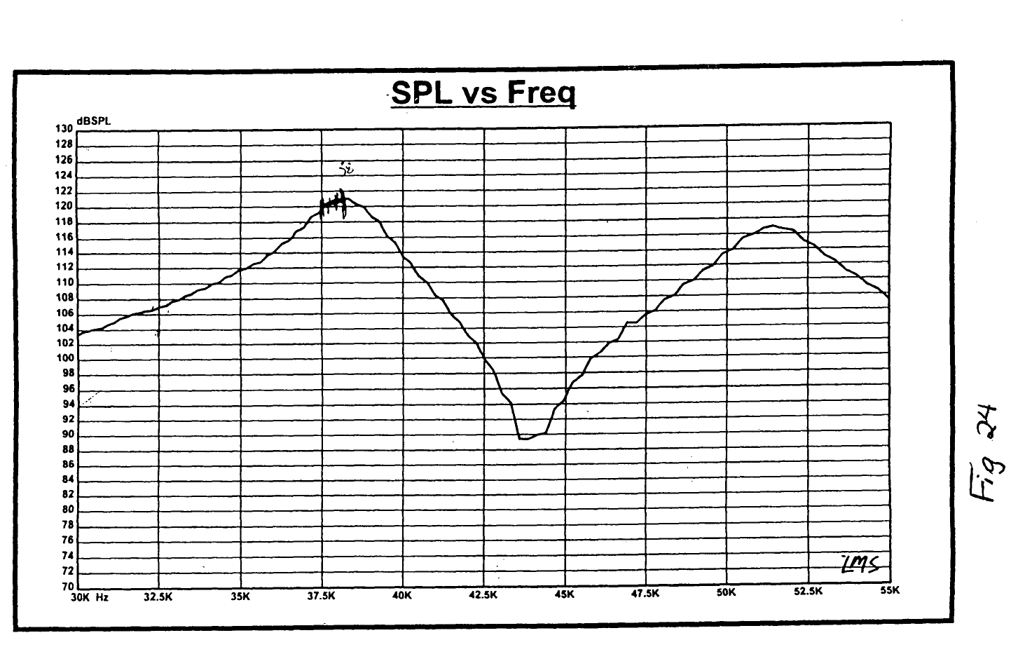

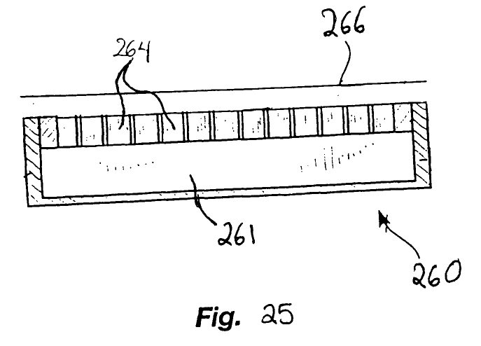

FIG. 24 is a graph showing frequency response of the emitter transducer of FIG. 4, produced in accordance with the principles of the preferred embodiment. It demonstrates surprising SPL outputs of approximately 120 db at frequencies of 38 KHz and 51.5 KHz.

Although the preferred embodiments of the present invention have been described as devices having closed-end cavities in which the cavities are not apertures or through-holes, the basic concept of the invention can also be implemented with apertures combined with a closed plenum space behind the apertures, thereby supplying the required “closed-end” configuration. Referring to FIG. 25, the support plate 260 includes a plenum 261 forming a large, closed end cavity. This plenum couples directly to an array of small apertures 264 which operate in a manner comparable to the closed-end cavities previously discussed.

In this case the film 266 is positioned at plate openings 264 which are coupled to the closed-end plenum 261 in the same manner as with the cavities of the support plate in the preferred embodiments. The device is then placed in a pressure chamber and the chamber is sealed and reduced to a near vacuum state. In this instance, the plenum captures the vacuum condition which is to be imposed upon the film emitter sections located over the apertures in the support plate. When the film, plate and plenum enclosure within the pressure chamber are withdrawn and exposed to ambient pressure, the film emitter sections deform in the same manner as with the preferred embodiments, enabling a permanent vacuum condition which is sealed for long term performance. Accordingly, the reference to a closed end cavity as contained in this disclosure may also be understood to relate to devices which include apertures coupled to a closed end cavity in accordance with the present invention, thereby enabling the sealing of the emitter film to a plate having openings which capture the pressure differential within the pressure chamber.

It should also be apparent from the description above that the preferred and alternative embodiments can emit sonic frequencies directly, without having to resort to the acoustical heterodyning process described earlier. However, the range of frequencies in the audible spectrum is necessarily limited to generally higher frequencies, as the invention is most effective in the mid-range and upper frequencies. Therefore, the greatest advantages of the present invention are realized when the invention is used to generate the entire range of audible frequencies indirectly using acoustical heterodyning as explained above.

Although emphasis has been placed on audio applications in the mid to high frequency range, low frequencies can be achieved with the present system. Direct generation of audio waves can be accomplished with large cavity configurations, including single cavity systems. These are useful for military and police applications where a directed sonic beam can be focused on a single person or group of individuals. Where frequencies are within the low range of less than 1000 Hz, the physiological response on humans can be disabling. This may be by either disrupting balance and equilibrium senses directly on the inner ear by direct impact of low, subwoofer frequencies, by using subsonic frequencies which trigger nausea and other disabling conditions. These frequencies can be generated either directly as audio output from the emitter, or as indirect, parametric output as discussed above.

It is to be understood that the above-described embodiments are only illustrative of the application of the principles of the present invention. Numerous modifications and alternative arrangements may be devised by those skilled in the art without departing from the spirit and scope of the present invention. The appended examples are intended to cover such modifications and arrangements.

We claim:

1. A method of preparing a parametric speaker transducer for (i) generating sonic or subsonic audio output by propagating two frequencies having a difference in value equal to the desired sonic or subsonic audio output and (ii) decoupling the two frequencies to generate the desired audio output, the method comprising the steps of:
a. positioning an electrically sensitive, mechanically responsive film over at least one closed-end cavity of a rigid support member within a pressure chamber;
b. applying a pressure differential within the chamber to provide a common cavity pressure substantially different from ambient pressure;
c. sealing the film to the support member while within the pressure chamber to capture the cavity pressure in a permanent configuration; and
d. removing the sealed film and support member from the pressure chamber, thereby distending the film into an arcuate emitter configuration with respect to the at least one cavity in response to a pressure differential between cavity pressure and ambient pressure on opposing sides of the film to enable constricting and extending of the emitter configuration in response to variations in an applied electrical input at the piezoelectric film to thereby create a compression wave in a surrounding environment.

2. A method for emitting subsonic, sonic or ultrasonic compression waves, said method comprising the steps of:
a. positioning a piezoelectric film over at least one closed-end cavity within a rigid support member, said support member having an outer face formed around the at least one cavity;
b. distending the piezoelectric film into an arcuate emitter configuration with respect to the at least one cavity in response to a pressure differential between cavity pressure and ambient pressure on opposing sides of the film to enable constricting and extending of the emitter configuration in response to variations in an applied electrical input at the piezoelectric film to thereby create a compression wave in a surrounding environment; and
c. applying electrical input to the piezoelectric film to propagate a desired compression wave.

3. A method as defined in claim 2, wherein the step of distending the film into the arcuate emitter configuration comprises the more specific steps of:
a. positioning the support member and the piezoelectric film within a chamber having a chamber pressure at a substantial pressure differential with respect to ambient pressure;
b. sealing the film to the outer face of the support member while in the chamber to capture the chamber pressure within the at least one cavity; and
c. removing the support member and sealed film from the chamber to an ambient pressure environment to thereby distend the film into the arcuate configuration with respect to the at least one cavity.

4. A method as defined in claim 3, comprising the more specific step of developing a negative pressure within the chamber, thereby creating a negative cavity pressure to distend the film into the arcuate configuration within the at least one cavity.

5. A method as defined in claim 4, wherein the negative pressure approximately corresponds to a vacuum.

6. A method as defined in claim 3, comprising the more specific step of developing a positive pressure within the chamber, thereby creating a positive cavity pressure to distend the film into the arcuate configuration away from the at least one cavity.

7. A method as defined in claim 3, comprising the more specific step of positioning the support member and the piezoelectric film in a spatially separated configuration within the chamber having a chamber pressure at a substantial pressure differential with respect to ambient pressure.

8. A method for emitting subsonic, sonic or ultrasonic compression waves, said method comprising the steps of:
a. positioning a piezoelectric film over an array of closed-end cavities formed within a rigid support member, said support member having an outer face formed around the array of cavities;
b. distending the piezoelectric film into an arcuate emitter configuration with respect to the cavities in response to a pressure differential between cavity pressure and ambient pressure on opposing sides of the film to enable constricting and extending of the emitter configuration in response to variations in an applied electrical input at the piezoelectric film to thereby create a compression wave in a surrounding environment; and
c. applying an electrical input to the piezoelectric film to propagate a desired compression wave.

9. A method as defined in claim 8, wherein the step of distending the film into an arcuate emitter configuration comprises the more specific steps of:
a. positioning the support member and the piezoelectric film within a chamber having a chamber pressure at a substantial pressure differential with respect to ambient pressure;
b. sealing the film to the outer face of the support member while in the chamber to capture the chamber pressure within the cavities; and
c. removing the support member and sealed film from the chamber to an ambient pressure environment to thereby distend the film into the arcuate configuration with respect to the cavities.

10. A method as defined in claim 9, comprising the more specific step developing a negative pressure within the chamber, thereby creating a negative cavity pressure to distend the film into the arcuate configuration within the at least one cavity.

11. A method as defined in claim 9, comprising the more specific step of positioning the support member and the piezoelectric film in a spatially separated configuration within the chamber having a chamber pressure at a substantial pressure differential with respect to ambient pressure.

12. A method as defined in claim 1, further comprising the step of forming the at least one cavity in a circular configuration.

13. A method as defined in claim 1, further comprising the step of forming the at least one cavity in an elliptical configuration.

14. A method as defined in claim 1, further comprising the step of forming the at least one cavity in an elongated slot configuration.

15. A method as defined in claim 1, further comprising the step of forming the at least one cavity in a serpentine configuration.

16. A method as defined in claim 1, further comprising the step of forming the at least one cavity in a spiral configuration.

17. A method as defined in claim 1, further comprising the step of forming the at least one cavity as an array of cavities forming a concentric configuration of rings.

18. A method as defined in claim 1, wherein the step of applying an electrical input comprises the more specific step of applying an ultrasonic parametric signal capable of decoupling when emitted in air to generate a sonic compression wave as part of a parametric speaker system.

19. A method as defined in claim 18, further comprising the step of optimizing the cavity configuration to have a resonant frequency coordinated with a carrier frequency of the ultrasonic parametric signal.

20. A method as defined in claim 1, comprising the more specific steps of:
a. positioning piezoelectric film over opposing closed-end cavities on opposing sides of and within a single rigid support member;
b. distending the piezoelectric film into an arcuate emitter configuration with respect to the opposing cavities in response to a pressure differential between cavity pressure and ambient pressure on opposing sides of the film at each cavity to enable constricting and extending of the emitter configuration in response to variations in an applied electrical input at the piezoelectric film to thereby create opposing compression waves in a surrounding environment; and
c. applying electrical input to the piezoelectric film to propagate the desired compression waves in opposing directions.

21. A method as defined in claim 20, wherein the step of distending the film into the arcuate emitter configuration comprises the more specific steps of:
a. positioning the support member and the piezoelectric film within a chamber having a chamber pressure at a substantial pressure differential with respect to ambient pressure;
b. sealing the film to opposing outer faces of the support member while in the chamber to capture the chamber pressure within the opposing cavities on each face of the support member; and
c. removing the support member and sealed film from the chamber to an ambient pressure environment to thereby distend the film into the arcuate configuration with respect to the cavities.

22. A method as defined in claim 20, further comprising the steps of forming apertures in the support member with terminal openings exposed on opposing sides of the support member and applying the film over opposing sides of the support member to form the closed-end cavities over respective ends of the apertures.

23. A method as defined in claim 1, wherein the step of distending the film into the arcuate emitter configuration comprises the more specific steps of:
a. positioning the piezoelectric film on the support member prior to placement within a the pressure chamber and modifying chamber pressure to a substantial pressure differential with respect to ambient pressure;
b. sealing the film to the outer face of the support member while in the chamber to capture the modified chamber pressure within the at least one cavity; and
c. removing the support member and sealed film from the chamber to an ambient pressure environment to thereby distend the film into the arcuate configuration with respect to the at least one cavity.

24. A method as defined in claim 2, further comprising the applying heat to the film after sealing at the support member.

25. A method as defined in claim 2, wherein the method of applying electrical signal is accomplished as part of a parametric sound emitter configured for generating near-field applications of sonic energy for direct exposure to listeners

26. A method as defined in claim 2, wherein the method of applying electrical signal is accomplished as part of a parametric sound emitter configured for generating far-field applications of sonic energy for indirect exposure to listeners by way of a virtual speaker location at a reflective surface.

27. A method as defined in claim 2, further comprising the step of directing the output of the emitter with low frequency emissions directly at an individual for physically disabling the individual.

28. A method as defined in claim 1, comprising the more specific step of forming the closed-end cavity as a depression extending within but not through the support member.

29. A method as defined in claim 1, comprising the more specific step of forming the closed-end cavity as a combination of at least one aperture through the support member communicating to an otherwise closed plenum chamber

30. A method of forming protuberances in piezoelectric material as a parametric emitter for an acoustic device, said method comprising the steps of:
a. providing a substrate having a plurality of closed-end cavities of a given dimension formed therein;
b. forming a laminate comprising a film of polymer piezoelectric material sandwiched between a first electrode layer on a top surface and a second electrode layer on a bottom surface of the polymer material;
c. positioning the substrate and the laminate within a low pressure environment;
d. securing the laminate to the substrate within the low pressure environment to form a sealed composite assembly which captures a low pressure state within the cavity between the substrate and the laminate; and
e. positioning the composite assembly in an ambient pressure environment to form protuberances in the film at the locations of the perforations.

31. The method of claim 30 further comprising the step of applying heat to the substructure and bonded piezoelectric film to accelerate the plurality of arcuate configurations to distend to a level of substantial stasis.

32. The method of claim 30 further comprising the step of applying heat to the substructure and bonded piezoelectric film to accelerate the bonding of the piezoelectric film to the substructure.

33. The method of claim 30 further comprising the step of sizing the plurality of cavities to form a resonance at a predetermined frequency.

34. The method of claim 30 further comprising the step of forming electrical connectivity to the first electrode layer of the piezoelectric film and the second electrode layer of the piezoelectric film for coupling to an electrical signal source.

35. A method as defined in claim 30, further comprising the steps
a. providing a second emitter substructure having an outer face oriented outward in a different direction than the outer face of the first substructure and having a plurality of closed-end cavities formed thereon;
b. providing a second piezoelectric film with a first conductive side and a second conductive side with the second film prepared to be adhered at the second side to the second substructure outer face;
c. placing the first and second piezoelectric films and the first and second emitter substructures in a vacuum chamber and substantially evacuating the air from the vacuum chamber;
d. bonding the first and second piezoelectric films to outer faces of the first and second substructures within the evacuated vacuum chamber to capture a low pressure condition in the cavities enclosed by the films and substructures;
e. removing the substructures and bonded piezoelectric films to be exposed to the external environment to allow atmospheric pressure to distend the piezoelectric thin films into concave arcuate configurations over the cavities; and
f. applying electrical input to both the first and second films to simultaneously generate compression waves in two different directions.

36. A method for constructing a piezoelectric emitter comprising:
a. providing an emitter substructure having at least one outer face having a closed-end cavity formed thereon;
b. providing a piezoelectric film with a first conductive side and a second conductive side with the film prepared to be attached to the substructure outer face;
c. placing the piezoelectric film and the emitter substructure in a vacuum chamber and substantially evacuating the air from the vacuum chamber;
d. bonding the piezoelectric film to at least one outer face of the substructure with the vacuum chamber in a low pressure state;
e. removing the substructure and bonded piezoelectric film to be exposed to the external environment to allow atmospheric pressure to distend the piezoelectric thin film into a concave arcuate region over the area of the cavity.

37. A method for constructing a piezoelectric emitter comprising:
a. providing an emitter plate having at least one outer face oriented outward and at least one inner face with at least one cavity extending between the outer and inner faces;
b. positioning a back cover against the inner face of the emitter plate to form a closed-cavity with the inner face being sealed off in relationship with the external environment;
c. providing a piezoelectric film with a first conductive side and a second conductive side with the film prepared to be attached to the emitter plate outer face;
d. placing the piezoelectric film and the emitter plate in a vacuum chamber and substantially evacuating the air from the vacuum chamber to a low pressure state;
e. bonding the piezoelectric film to outer face of the emitter plate to seal the cavity with a cavity pressure at the low pressure state;
f. removing the substructure and bonded piezoelectric film to be exposed to the external environment to allow atmospheric pressure to distend the piezoelectric thin film into a concave arcuate region over the area of the cavity.

38. An ultrasonic transducer apparatus comprising:
a substrate having an array of closed-end cavities including an open side respectively formed therein at predetermined positions on the substrate such that the array forms a given area within the substrate;
a layer of polymeric piezoelectric material with opposing conductive sides and being disposed on the substrate to seal the open side of the cavities, the layer of piezoelectric material having a plurality of protuberances each being defined by a respective portion of the piezoelectric material extending into a corresponding one of the closed-end cavities, the plurality of protuberances being substantially permanently formed by a pressure differential existing between the sealed cavity and ambient room pressure and defining an active area of the transducer corresponding to the given area of the substrate; wherein a resonance frequency of the transducer is a function of a shape of the protuberances as determined by at least one dimension of the cavities, and wherein a vertical and horizontal beam angle associated with the transducer is controllable as a function of the dimensions of the active area of the transducer.

39. A flat ultrasonic transducer comprising:
a substrate having a plurality of closed-end cavities formed therein;
a layer of polymeric piezoelectric material disposed on the substrate, the layer of piezoelectric material including a plurality of protuberances defined by portions of the piezoelectric material extending into corresponding ones of the cavities in response to a pressure differential existing between pressure within the cavities and ambient room pressure, the plurality of protuberances defining an active area of the transducer; wherein the resonance frequency of the transducer is a function of a curvature of each of the protuberances as determined by at least one dimension of the cavities, and wherein the output power is controllable as a function of the ratio of the active area to the total substrate area.

40. A transducer comprising:
a substrate having a plurality of closed-end cavities formed therein;
a layer of polymeric piezoelectric material disposed along the substrate, the layer of piezoelectric material including a plurality of protuberances of a given curvature, the protuberances each being defined by portions of the piezoelectric material extending into a corresponding one of the closed-end cavities in response to a pressure differential between the cavity pressure and ambient room pressure, the plurality of protuberances defining an active area of the transducer;
contact means coupled to the piezoelectric material for providing an electrical input to cause vibration of said protuberances at a predetermined frequency which is independent of the radius of curvature of the substrate.

41. An ultrasonic transducer assembly comprising:
an ultrasound transducer including:
a substrate including top and bottom surfaces, the substrate including a conductive material at the top surface and including a plurality of closed-end cavities formed therein;
a laminate comprising a film of a polymer piezoelectric material sandwiched between a first electrode layer on a top surface and a second electrode layer on a bottom surface, the laminate disposed on the top surface of the substrate, the laminate including a plurality of protuberances each of a given curvature and respectively extending into a corresponding one of the closed-end cavities based on a pressure differential existing between cavity pressure and ambient pressure; and
a housing containing the ultrasound transducer, the housing including an open end and a closed end, the housing comprising:
a first contact in electrical communication with the first electrode layer;
a second contact in electrical communication with the second electrode layer;
means coupled to the first contact for providing a first electrical connection through the closed end to provide a first terminal for connection to a first electrical potential; and
means coupled to the second contact for providing a second electrical connection through the closed end to provide a second terminal for connection to a second electrical potential; whereby the substrate is operative to provide mechanical protection to the transducer laminate and to electrically couple the first and second electrode layers each to a corresponding terminal.

42. A speaker device for emitting subsonic, sonic or ultrasonic compression waves, said device being comprised of:
a rigid emitter support member having an outer face that includes at least one closed-end cavity with a single exposed opening at the outer face of the support member;
a thin piezoelectric film disposed across and sealed to the outer face of the emitter support member, said film being distended into an arcuate emitter configuration with respect to the at least one cavity in response to a pressure differential between cavity pressure and ambient pressure on opposing sides of the film;
said film being capable of constricting and extending in response to variations in an applied electrical input to thereby create a compression wave in a surrounding environment.

43. A speaker device for emitting subsonic, sonic or ultrasonic energy waves, the device being comprised of:
an emitter substructure having at least one outer face oriented outward;
the emitter substructure having a plurality of cavities on the outer face of the emitter substructure;
a thin piezoelectric film disposed across the cavities of the emitter plate in a substantially sealed off relationship relative to the external environment;
electrical contacts coupled to the piezoelectric film for providing an applied electrical input;
a pressure differential applied between the configurations of cavities and the external environment for developing a biasing pressure with respect to the thin film at the cavities to distend the film into an emitter configuration with arcuate configurations capable of constricting and extending in response to variations in the applied electrical input at the piezoelectric film to thereby create an energy wave in a surrounding environment.

44. The speaker device in claim 43 wherein the plurality of cavities are individually circular in shape.

45. The speaker device in claim 43 wherein the plurality of cavities are individually elliptical in shape.

46. The speaker device in claim 43 wherein the plurality of cavities include elongated slot configurations.

47. The speaker device in claim 43 wherein the plurality of cavities form concentric rings.

48. The speaker device in claim 43 wherein the plurality of cavities form a spiral.

49. The speaker device in claim 43 wherein a multiplicity of separate emitter structures are configured to operate together as a single speaker device.

50. The speaker device of claim 43 wherein the speaker device is optimized to operate as an ultrasonic emitter for use as a parametric speaker system.

51. The speaker device of claim 50 wherein the speaker device is optimized to have a resonant frequency that is coordinated with a carrier frequency of the parametric loudspeaker system.

52. The speaker device of claim 51 wherein the speaker device is utilized below the resonant frequency in coordination with a parametric loudspeaker operated in lower sideband mode.

53. The speaker device in claim 43 wherein the emitter substructure is configured as a flat plate.

54. The speaker device in claim 43 wherein the emitter substructure is configured as a convex curved plate.

55. The speaker device in claim 43 wherein the emitter substructure is configured as a concave curved plate.

56. The speaker device in claim 43 wherein the emitter substructure is configured as a cylindrical device.

57. The speaker device in claim 43 wherein the emitter substructure has at least a second outer face oriented outward in a different direction from the first outer face and including at least one closed-end cavity therein, and the thin piezoelectric film is also disposed across the second outer face, said film being distended into an arcuate emitter configuration with respect to the at least one cavity in response to a pressure differential between cavity pressure and ambient pressure on opposing sides of the film, the emitter substructure being configured as a bidirectional device projecting sound in at least two different directions.

58. A speaker device for emitting subsonic, sonic or ultrasonic energy waves, the device being comprised of:
an emitter substructure having at least one outer face oriented outward, the emitter substructure having at least one closed-cavity on the outer face of the emitter substructure;
a thin piezoelectric film disposed across the cavity of the emitter plate in a substantially sealed off relationship relative to the external environment;
electrical contacts coupled to the piezoelectric film for providing an applied electrical input;
a pressure differential applied between the cavity and the external environment for developing a biasing pressure with respect to the thin film at the cavity to distend the film into an emitter configuration with an arcuate region capable of constricting and extending in response to variations in the applied electrical input at the piezoelectric film to thereby create an energy wave in a surrounding environment.

59. A method for indirectly propagating parametric sound a predetermined distance as part of a parametric sound system; the method comprising the steps of:
a) selecting an approximate limiting distance for which parametric sound is to be propagated such that beyond the limiting distance sound pressure level is nominal;
b) identifying a maximum sound pressure level at which the parametric sound system is to be operated;
c) selecting an ultrasonic carrier frequency for the parametric sound system that is sufficiently high so that propagated ultrasonic output of the sound system is sufficiently attenuated within the selected limited distance to limit propagation of the parametric sound to nominal levels beyond the limiting distance; and
d) operating the parametric sound system at the selected ultrasonic carrier frequency and approximately at or below the identified maximum sound pressure level.

60. A method as defined in claim 59, further applied as part of an audio broadcasting system for use in an environment where transient persons can receive broadcast information only when in direct proximity to the parametric sound system, said method comprising the steps of:
a) positioning the parametric sound system along an intended traffic area for transient persons;
b) orienting propagation of the parametric sound toward a region of intended exposure of the transient persons;
c) activating the parametric sound system as persons move toward the region of intended exposure; and
d) propagating the broadcast information to the transient persons as they pass through the region.
